(19) United States
(12) Patent Application Publication
(10) Pub. No.: US 2016/0379174 A1
(43) Pub. Date: Dec. 29, 2016

(54) System and Method for Coordinating the Activities of Locomotory Creatures

(71) Applicant: Meena Yust, Willmette, IL (US)

(72) Inventor: Meena Yust, Willmette, IL (US)

(21) Appl. No.: 15/197,690

(22) Filed: Aug. 26, 2016

Related U.S. Application Data
(60) Provisional application No. 62/231,220, filed on Jun. 29, 2015.

(51) Int. Cl. G06Q 10/10; H04L 29/08; H04W 4/02

(52) U.S. Cl. CPC G06Q 10/1095; H04W 4/021; H04L 67/306; H04L 67/104

(57) ABSTRACT

A system and method are provided to facilitate pet owners meeting other pet owners having similar pets, and allowing the pets and their owners to mingle and socialize with one another. The system and method may be adapted for use with any species of pet. Alternative embodiments may also be adapted for facilitating runners or other fitness conscious individuals to meet and coordinate work outs with other like-minded fitness conscious individual. Still other alternative embodiments may be adapted for facilitating the coordination family or children's activities amongst a community of similarly situated families. A preferred embodiment facilitates the coordination of dog walking activities among users by communicating information about a first dog owner and his or her dog to one or more other dog owners located in the same general area as the first dog owner. Similar information about the other dog owners and their dogs is communicated to the first dog owner. Based on the information received by the first dog owner about the other dog owners and dogs located in the first dog owner's vicinity, the first dog owner may choose when and where he or she decides to walk his or her dog in order to increase the likelihood that they will meet up with known friendly dog owners and their dogs. Similarly, the first dog owner may use the information about nearby dog owners and dogs to avoid meeting dog owners and dogs with whom the first dog owner or the first dog owner's dog are not friendly.

### CROSS-REFERENCE TO RELATED APPLICATION

This application claims the benefit of U.S. Provisional Application No. 62/231,220, filed Jun. 29, 2015.

### BACKGROUND OF THE INVENTION

Social media abound on the internet. Innumerable Applications exist allowing users to communicate with friends or groups of friends, or even complete strangers. Such applications typically allow users to share every everything from photos, to recipes, to music and just about any other information that is capable of being digitized and transmitted over the internet. Some websites provide interactions among subscribers geared toward sharing information about pets. There are no websites or social media applications, however, that are geared solely toward sharing information about the routes pet owners follow when the take their pets out for walks, and sharing the times at which they will be out walking their pets.

A need exists for an online system whereby pet owners may publish profiles of their pets and view the profiles of other pet owner and their pets in their local area, capable of publishing the times at which pet owners are out walking their pets and the routes they intend to take while they are out on their walks. Such a system should also be capable transmitting messages between pet owners so that they can coordinate their walks to make sure that their pets have the opportunity to socialize with one another. Such a system should include mapping and GPS technology so that the location of pet owners and their pets may be communicated to other pet owners. Intended routes and the current locations of pet owners should be conveniently displayed on a map so that the user can easily discern where the various pet owners are located with their pets and the destinations to which they are traveling.

### SUMMARY OF THE INVENTION

The present invention relates to a system for facilitating communication between pet owners and the coordination of the activities of pet owners and their pets. The system allows users to efficiently plan meetups with other pet owners and their pets during their daily walks. The system further provides a convenient way for pet owners to stay in touch with one another.

The system allows a user who is out walking his or her pet, or who is preparing to head out on a walk with his or her pet, to log into a network application using a computer, smartphone, tablet computer or other communication/computing device. The network may provide a list of other pet owners and their pets who frequently walk in the same neighborhood as the user. The list may be sorted by species/breed, geographical location, or any other pertinent criteria. For example, a list might consist of only close acquaintances within the pet walking community. Alternatively, a list might include a group of pets and pet owners who frequent a particular park, or who typically walk along a particular street at a particular time. Using the system, the user may publish the time when he or she is planning to start her walk to the community of online pet owners. Likewise, the user may publish a schedule of the times at which the user typically walks his or her pet. The system further facilitates the creation of connections, or friend relationships, between users and their pets who agree to be so connected.

### BRIEF DESCRIPTION OF THE DRAWINGS

FIG. 1 is a system diagram of an online system for coordinating the outdoor activities of pet owners and their pets;

FIG. 2 is Login interface page for a mobile application component of the system of FIG. 1;

FIG. 3 is a First Sign Up interface page for the mobile application component of the system of claim 1;

FIG. 4 is a Second Sign Up interface page for the mobile application component of the system of claim 1;

FIG. 5 is a Third Sign Up interface page for the mobile application component of the system of claim 1;

FIG. 6 is a Fourth Sign Up interface page for the mobile application component of the system of claim 1;

FIG. 7 is a Fifth Sign Up interface page for the mobile application component of the system of claim 1;

FIG. 8 is a sixth Sign Up interface page for the mobile application component of the system of claim 1;

FIG. 9 is a Congratulation interface page for the mobile application component of the system of claim 1;

FIG. 10 is a Home interface page for the mobile application component of the system of claim 1;

FIG. 11 is a My Profile interface page for the mobile application component of the system of claim 1;

FIG. 12 is an Edit Profile interface page for the mobile application component of the system of claim 1;

FIG. 13 is a Limited Profile interface page for the mobile application component of the system of claim 1;

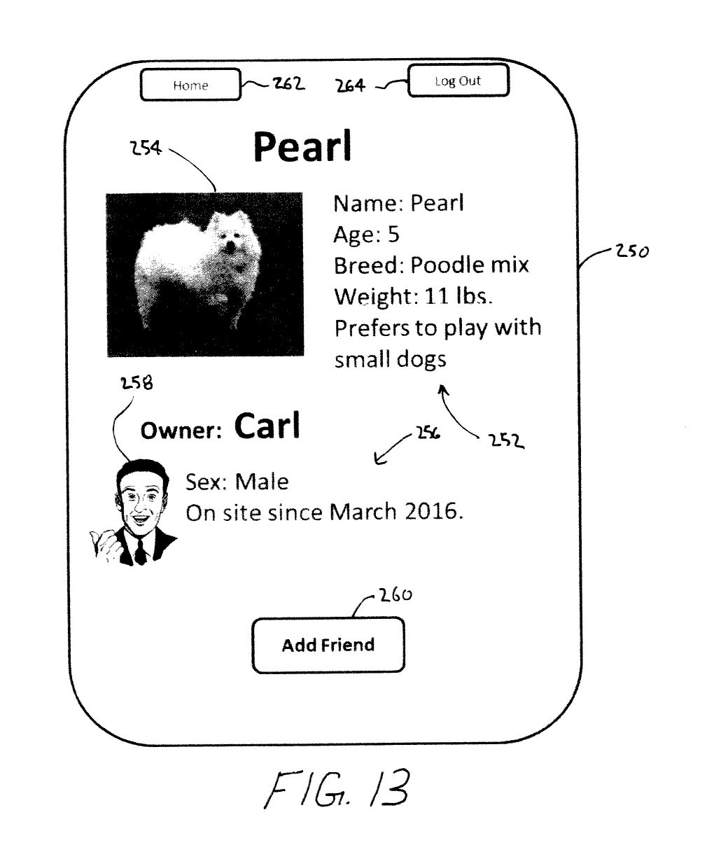

FIG. 14 is a Messages interface page for the mobile application component of the system of claim 1;

FIG. 15 is a Dogs in Your Neighborhood interface page for the mobile application component of the system of claim 1;

FIG. 16 is a Request Friend interface page for the mobile application component of the system of claim 1;

FIG. 17 is a Friend Request Message Sent interface page for the mobile application component of the system of claim 1;

FIG. 18 is a Friends interface page for the mobile application component of the system of claim 1;

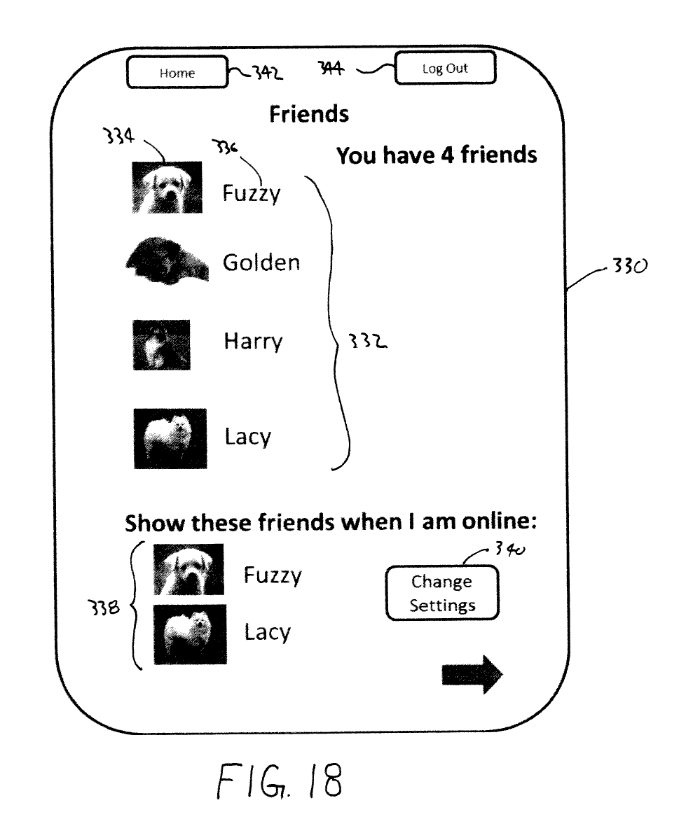

FIG. 19 is a Walk Time interface page for the mobile application component of the system of claim 1;

FIG. 20 is Time Submitted interface page for the mobile application component of the system of claim 1;

FIG. 21 is a Leave Away Message interface page for the mobile application component of the system of claim 1;

FIG. 22 is an Away Message Submitted interface page for the mobile application component of the system of claim 1;

FIG. 23 is a Your Route interface page for the mobile application component of the system of claim 1;

FIG. 24 is a Route Submitted interface page for the mobile application component of the system of claim 1;

FIG. 25 is a Your Neighborhood interface page for the mobile application component of the system of claim 1;

FIG. 26 is a Pop-Up Window within the Your Neighborhood interface page for the mobile application component of the system of claim 1;

FIG. 27 is an Expected Route interface page for the mobile application component of the system of claim 1;

FIG. 28 is an Away Messages interface page for the mobile application component of the system of claim 1;

FIG. 29 is a Profile interface page for the mobile application component of the system of claim 1;

FIG. 30 is a Send Message interface page for the mobile application component of the system of claim 1;

FIG. 31 is a Message Sent confirmation interface page for the mobile application component of the system of claim 1;

FIG. 32 is a First Change Friends Settings interface page for the mobile application component of the system of claim 1;

FIG. 33 is a Second Change Friends Setting interface page for the mobile application component of the system of claim 1;

FIG. 34 is a Changed Settings confirmation interface page for the mobile application component of the system of claim 1;

FIG. 35 is a Log Out interface page for the mobile application component of the system of claim 1; and

FIG. 36 is a Logged Out interface page for the mobile application component of the system of claim 1.

### DETAILED DESCRIPTION OF THE INVENTION

The present invention relates to a system to facilitate pet owners meeting other pet owners having similar pets, allowing the pets and their owners to mingle and socialize with one another. The system may be adapted for use with any species of pet. In fact, the system may even be adapted for use by parents having infants or toddlers. A preferred embodiment of the invention, however, is especially adapted to help dog owners meet up with other dog owners. This embodiment allows dog owners to coordinate their dog walking activities so that their dogs are more likely to encounter other dogs with whom they are familiar and with whom they get along, while avoiding other dogs with whom they do not. The remainder of this description will describe an embodiment of the invention related to dogs. Those skilled in the art, however will note that other embodiments geared to any other locomotory creatures may be envisioned.

The present invention facilitates the coordination of dog walking activities among users by communicating information about a first dog owner and his or her dog to one or more other dog owners located in the same general area as the first dog owner. Similar information about the other dog owners and their dogs is communicated to the first dog owner. Based on the information received by the first dog owner about the other dog owners and dogs located in the first dog owner's vicinity, the first dog owner may choose when and where he or she decides to walk his or her dog in order to increase the likelihood that they will meet up with known friendly dog owners and their dogs. Similarly, the first dog owner may use the information about nearby dog owners and dogs to avoid meeting dog owners and dogs with whom the first dog owner or the first dog owner's dog are not friendly.

As will be described in more detail below, the information exchanged between dog owners may include, but need not be limited to: owner profile data; dog profile data; an owner's current status (e.g. online/offline, or out walking/not walking), current location, current direction of travel and intended route. The information about other dog owners and their dogs who are present in the first dog owners area may be displayed on a user interface device associated with the first dog owner. The user interface device may comprise, for example, the first dog owner's smartphone, tablet computer, laptop or desktop computer, or the like.

According to an embodiment of the invention, a map is displayed on a first dog owner's interface device. The map displays one or more icons showing the current location of other dog owners and their dogs who are nearby and who are currently online or out for a walk. The map may also display the intended route that each of the other dog owners intend to follow on their present walk as well as their present direction of travel. Armed with this information, the first owner may plan his or her own route in order to intercept one or more other dog owners and their dogs in order to meet along the way and allow the dogs to play with one another. Conversely, the first dog owner may use the information about other dog owners and their dogs in the vicinity to avoid one or more dog owners or dogs whom the first dog owner would prefer not to meet.

The system of the present invention further allows dog owners to send messages to one another about their intended dog walking activities. Such messages may be sent to individual dog owners, a select group of dog owners, or en masse to all dog owners within a given geographical area.

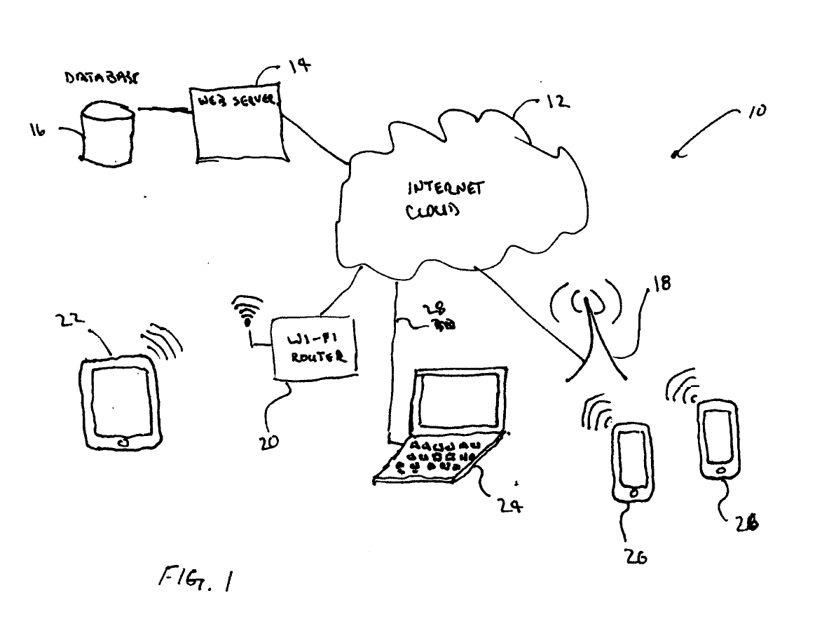

Turning now to FIG. 1, a system 10 for facilitating coordinated dog walking activities is shown. The system 10 includes a web server 14, a data store 16 and a plurality of user interface devices, such as for example, a tablet computer 22, a laptop or desktop computer 24, or a smartphone 26. The user interface devices may connect to the internet 12 wirelessly via a Wi-Fi router 20, an LTE data or cellular connection 18 or some other wireless communication method. Alternatively, a desktop computer 24 may connect to the internet 12 directly via a hard wired network connection 28. The features provided by the present invention are most useful when a dog owner is out walking his or her dog or when the owner is preparing to go for a walk. Accordingly, the preferred user interface device will generally be a smartphone 26, or some other mobile computing device. The remainder of the present description will refer to the user input device as smartphone 26, however, those skilled in the art will recognize that the user interface device may be any suitable computing device capable of sending and receiving data over the internet 12 as well as receiving input data from the user and displaying output data to the user. Each user's smartphone 26 includes a software application adapted to present a plurality of interactive user interface pages to the user. As will be described more fully below, the user interface pages are adapted to elicit input data from a user about the user and the user's dog. The software application executed by the dog owner's smartphone is further adapted to communicate the data about the dog owner and the dog owner's dog to the web server 14 over the internet 12, where it is stored in the data store 16.

The data about the user and the user's dog collected by the dog owner's smartphone and transmitted to the web server 14 and stored in the data store 16, as well as the data about other users and their dogs pulled from the data store 16 and transmitted to and displayed by the user's smartphone 26 is most easily understood by reviewing the user interface presented to the user by the user's smartphone 26.

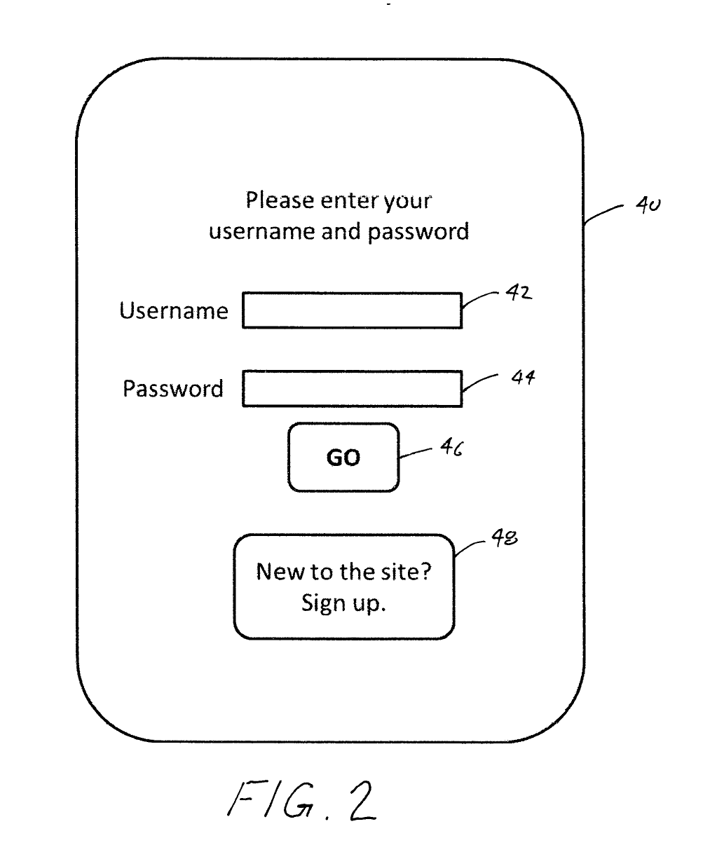

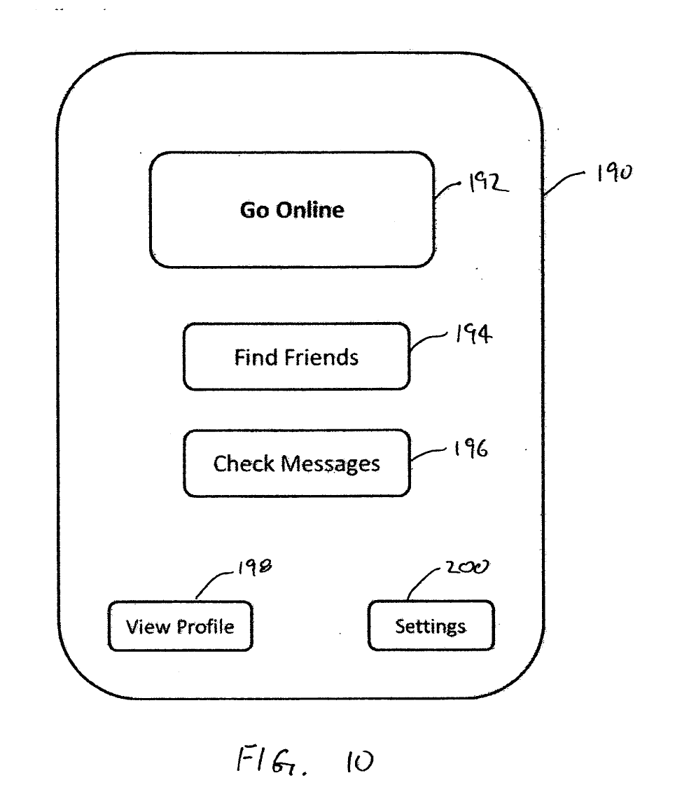

Turning to the user interface, FIG. 2 is a Login screen 40 that the application executed on the user's smartphone causes to be displayed on the user's smartphone's display screen when the when the user opens the dog walking application on the device. The login screen 40 includes a Username text field 42, a Password text field 44, a Go button 46, and a Sign Up button 48. The user interface allows the user to enter text characters into the Username and Password text fields 42, 44 as is well known in the art. Once the user has entered his or her Username and Password into the Username and Password text fields 44, 44, the user may select the Go button 46 to logon to the application and access a previously established user account. The system verifies the username and password entered by the user. If the user name and password correspond to a previously established account, the user's smartphone 26 displays a Home page 190 as shown in FIG. 10. If the user is new to the application and has not yet established a user account, the user may select the Sign Up button 48.

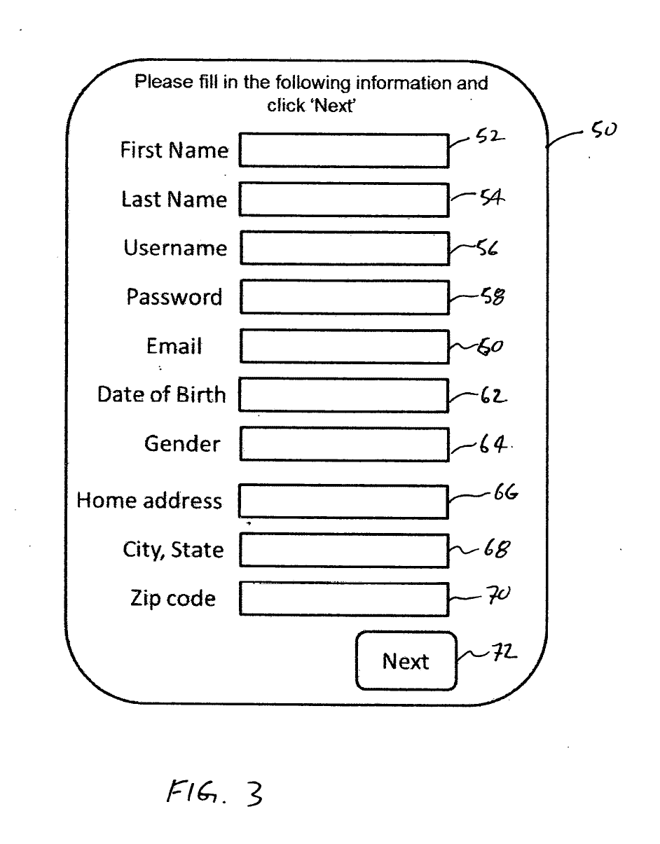

FIGS. 3-9 are user interface pages associated with the creation of a new user account. The user's smartphone displays the first Sign Up page 50 shown in FIG. 3 when the user selects the Sign Up button 48 from the Login screen 40 of FIG. 2. The Sign Up page 50 includes a number of text fields for receiving information about the user. The text fields on the first Sign Up Page 50 include: First Name 52; Last Name 54; Username 56; Password 58; Email 60; Date of Birth 62; Gender 64; Home Address 66; City, State 68; and Zip Code 70. The first Sign Up page 50 further includes a Next button 72. A prompt at the top of the Sign Up Page 50 instructs the user to enter the appropriate information into the various text fields 52, 54, 56, 58, 60, 62, 64, 66, and to select the Next button 72.

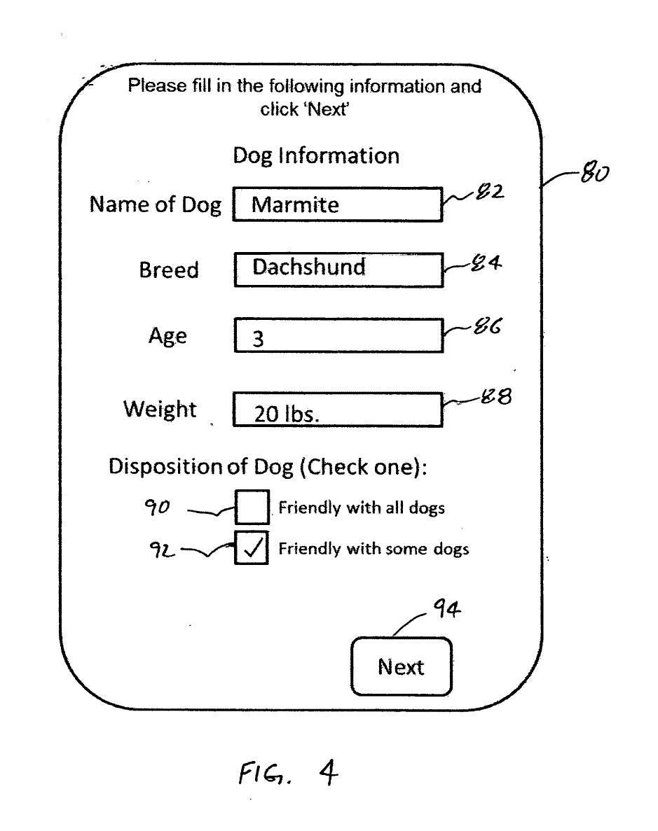

Upon the user entering the appropriate information in the text fields 52, 54, 56, 58, 60, 62, 64, 66, and selecting the Next button 72, the user's smartphone 26 displays the second Sign Up page 80 shown in FIG. 4. The second Sign Up page 80 includes a number of text fields for receiving information about the user's dog. The text fields on the second Sign Up page 80 include: Name of Dog 82; Breed 84; Age 86; and Weight 88. The second Sign Up page 80 also includes a pair of checkboxes 90, 92 relating to the dog's disposition. The first checkbox 90 indicates that the dog is friendly with all dogs, and the second checkbox 92 indicates that the dog only friendly with some dogs. The user signing up for the first time can select whichever checkbox 90, 92 is appropriate. The Sign Up page 80 further includes a Next button 94. A prompt at the top of the Second Sign Up Page 80 instructs the user to enter the appropriate information into the various text fields 82, 84, 86, 88, and to select the appropriate checkbox 90, 92 and to select the Next button 94.

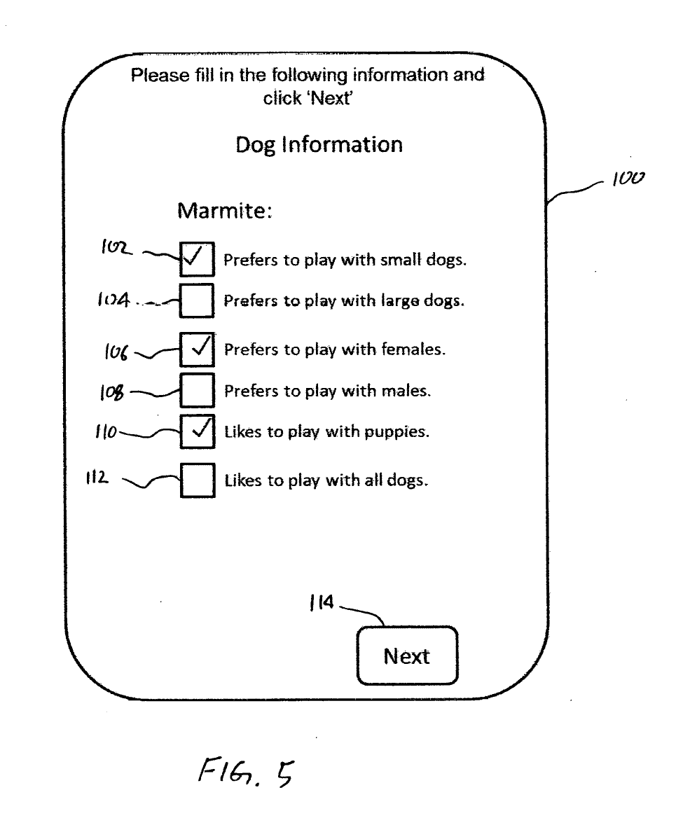

After the user has entered the appropriate information in the second Sign Up page 80 and selected the Next button 94, the user's smartphone displays the third Sign Up page 100 shown in FIG. 5. The third Sign Up page 100 elicits further information from the user about the user's dog. The third Sign Up page 100 includes a plurality of checkboxes 102, 104, 106, 108, 110, 112 relating to various canine preferences. The user may select all of the checkboxes that apply to his or her dog. The checkboxes included on the third Sign Up page 100 include: Prefers to play with small dogs 102; Prefers to play with large dogs 104; Prefers to play with females 106; Prefers to play with males 108; Likes to play with puppies 110; Likes to play with all dogs 112. The third Sign Up page 100 further includes a Next button 114. A prompt at the top of the third Sign Up Page 100 instructs the user to enter the appropriate information and to select the Next button 114.

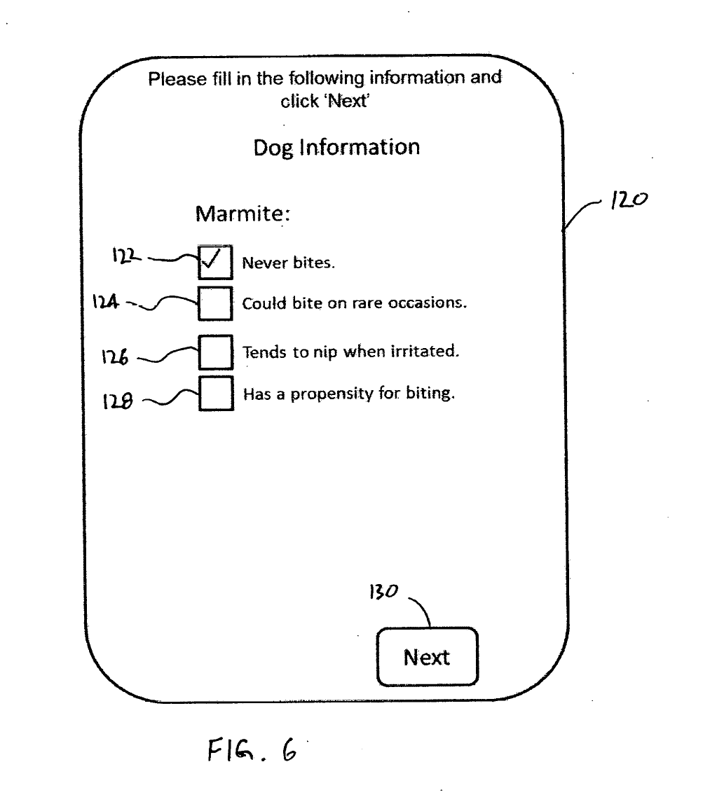

Upon selecting the applicable checkboxes 102, 104, 106, 108, 110, 112 and selecting the Next button 114, the user's smartphone displays the fourth Sign Up page 120 shown in FIG. 6. The fourth Sign Up page 120 includes additional checkboxes 122, 124, 126, 128 describing additional behavioral characteristics common to many dogs. The checkboxes on the fourth Sign Up page 120 include: Never bites 122; Could bite on rare occasions 124; Tends to nip when irritated 126; and Has a propensity for biting 128. Again the user may select whichever checkbox corresponds to his or her dog's typical behavior. A prompt at the top of the fourth Sign Up page 120 instructs the user to select the appropriate checkbox or checkboxes and to select the Next button 130.

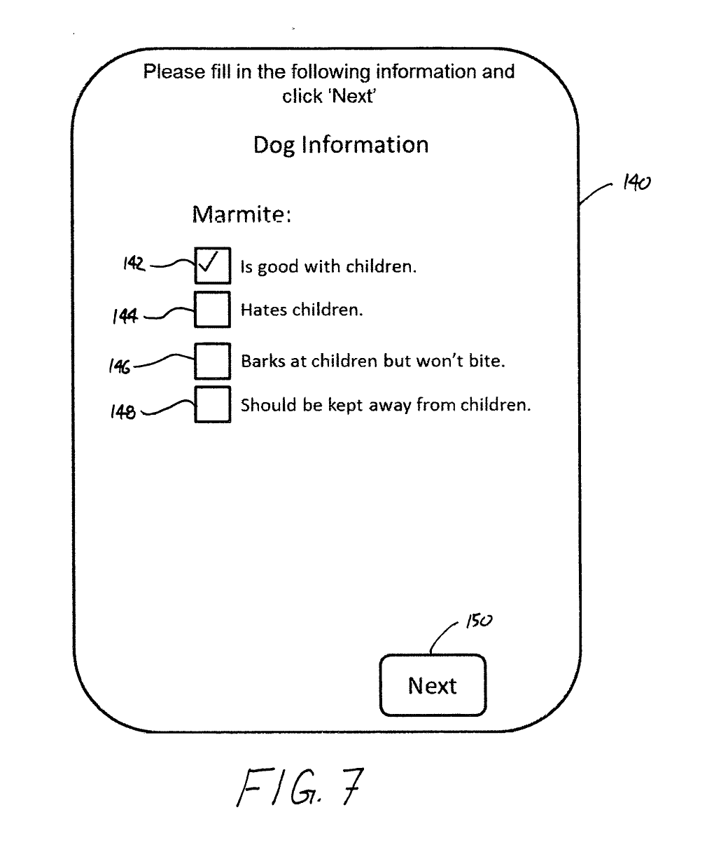

Selecting the Next button 130 on the fourth Sign up page 120 causes the user's smartphone to display the fifth Sign Up page 140 shown in FIG. 7. The fifth Sign Up page 140 elicits yet more information from the user about the user's dog. The fifth Sign Up page 140 includes a plurality of checkboxes 142, 144, 146, 148, relating to additional aspects of the dog's behavior. The checkboxes included on the fifth Sign Up page 140 include: Is good with children 142; Hates children 144; Barks at children but won't bite 146; and Should be kept away from children 148. A prompt at the top of the fifth Sign Up Page 140 instructs the user to enter the appropriate information and to select the Next button 150.

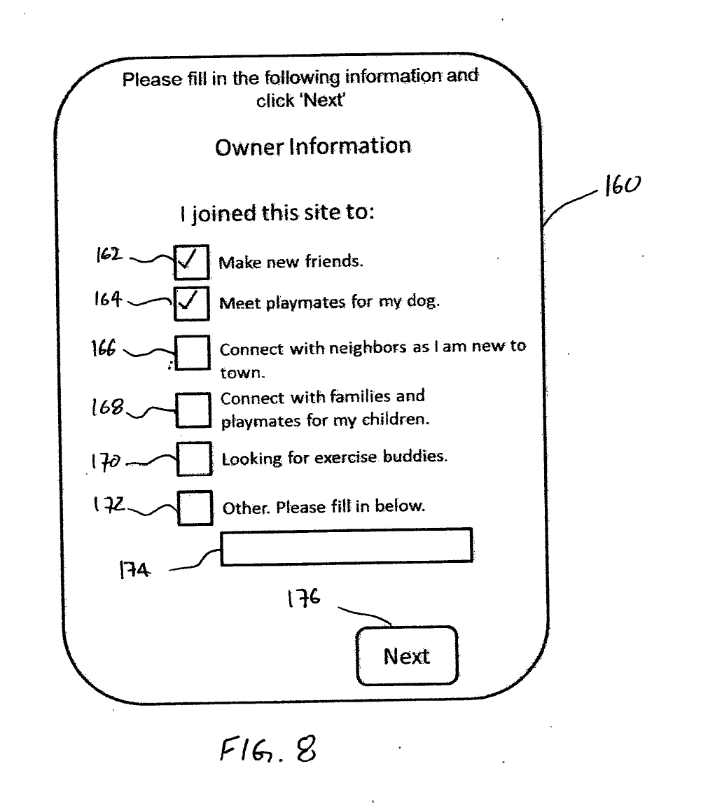

Upon selecting the applicable checkboxes 142, 144, 146, 148 and selecting the Next button 150, the user's smartphone displays the sixth Sign Up page 160 shown in FIG. 8. The sixth Sign Up page 160 includes additional checkboxes 162, 164, 166, 168, 170, and 172 relating to the reasons why the user is choosing to join the dog walking community enabled by the present invention. The checkboxes on the sixth Sign Up page 160 include: Make new friends 162; Meet playmates for my dog 164; connect with neighbors as I am new to town 166; Connect with families and playmates for my children 168; Looking of exercise buddied 170; and Other 172. A text field 174 is also provided to allow the user to describe other reasons the user has chosen to join the dog walking community. A prompt at the top of the sixth Sign Up page 160 instructs the user select the appropriate checkbox or checkboxes and to select the Next button 176.

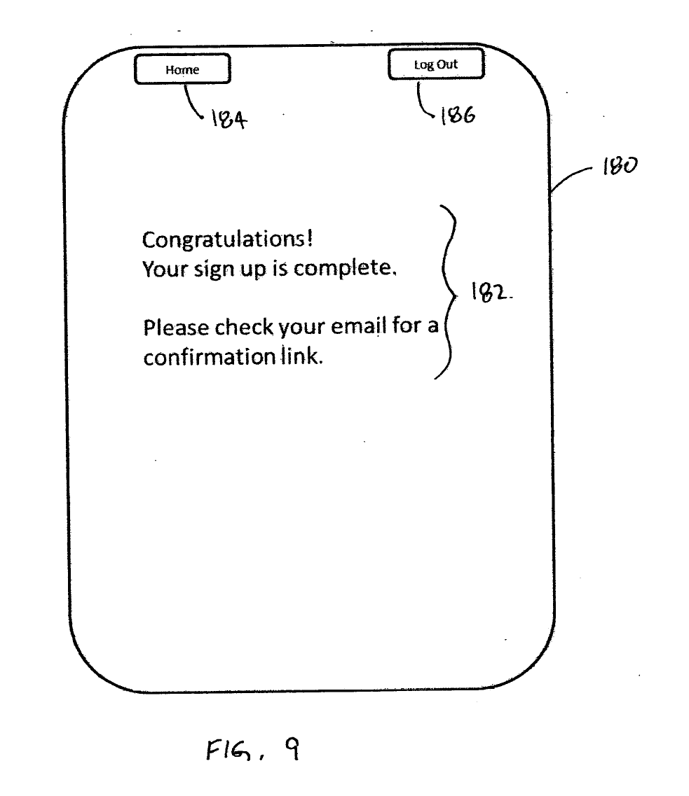

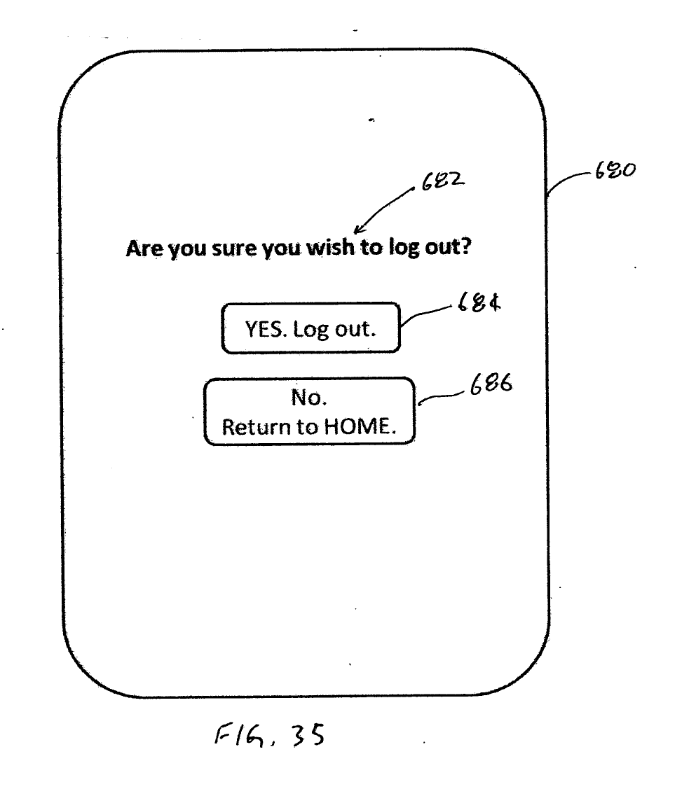

Selecting the Next button 176 on the sixth Sign Up page 160 completes the sign up process. Upon completion of the sign up process the user's smartphone displays the Congratulations page 180 depicted in FIG. 9. The Congratulations page 180 includes a congratulatory message 182 indicating the sign up process is complete and instructing the user to check his or her email for a confirmation link. The Congratulations page 180 further includes a Home button 182 and a Log Out button 184. Selecting the Home button 184 on the congratulations page 184 causes the user's smartphone to display the Home page 190 depicted in FIG. 10. Selecting Log Out button 186 on the Congratulation page 180 causes the user's smartphone to display the Log Out page 680 shown in FIG. 35 also described in more detail below.

Returning briefly to FIG. 1, the information entered by the user in the various sign up pages during the sign up process is transmitted to the web server 14 via the internet 12 and stored as a user profile in the data store 16.

Returning to FIG. 10, the Home page 190 is the initial page from which the user may access the primary features of the application. The Home page 190 may be reached by selecting the Go button 46 on the Login page 40 (FIG. 2) or when the user selects a Home button on one of the many other interface pages described below. The Home page 190 displays a number of user selectable buttons: Go Online 192; Find Friends 194; Check Messages 196; View Profile 198; and Settings 200.

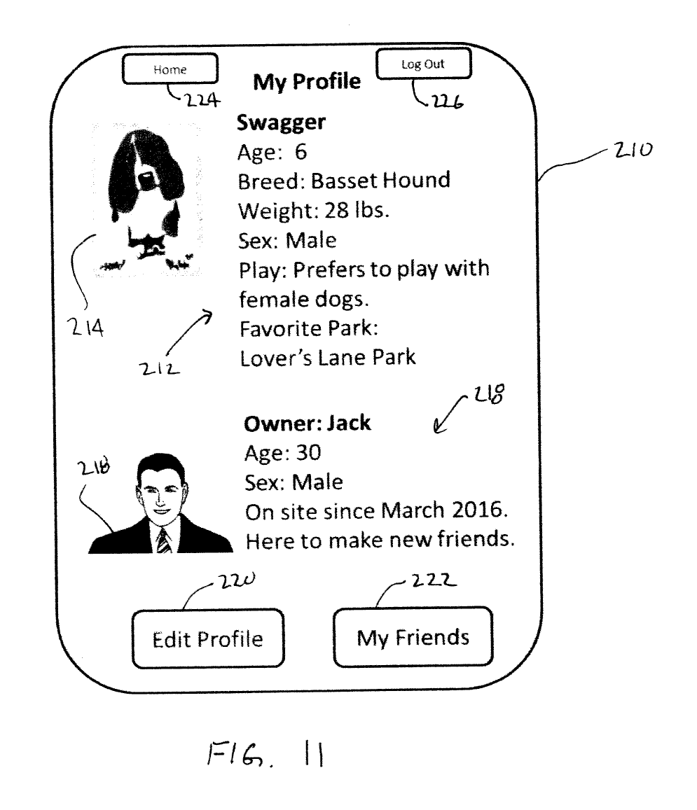

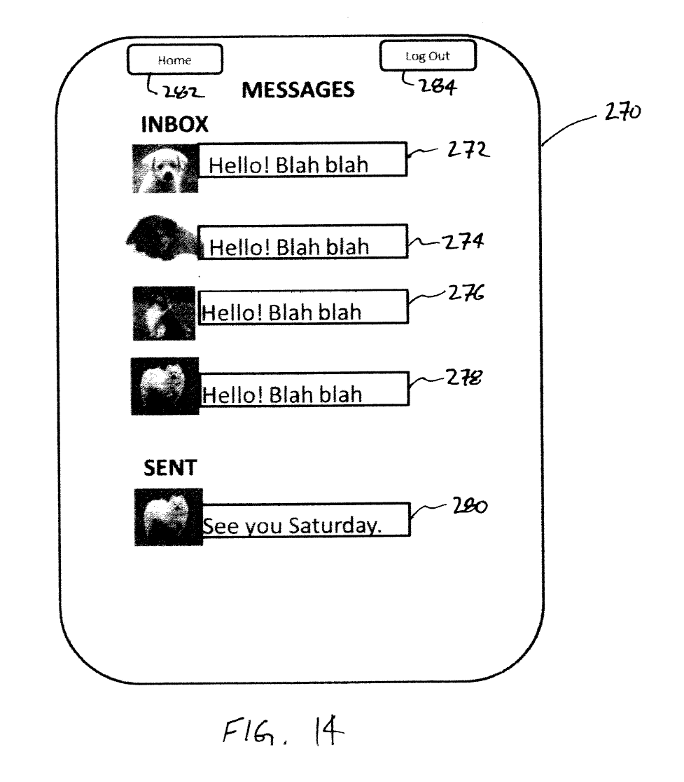

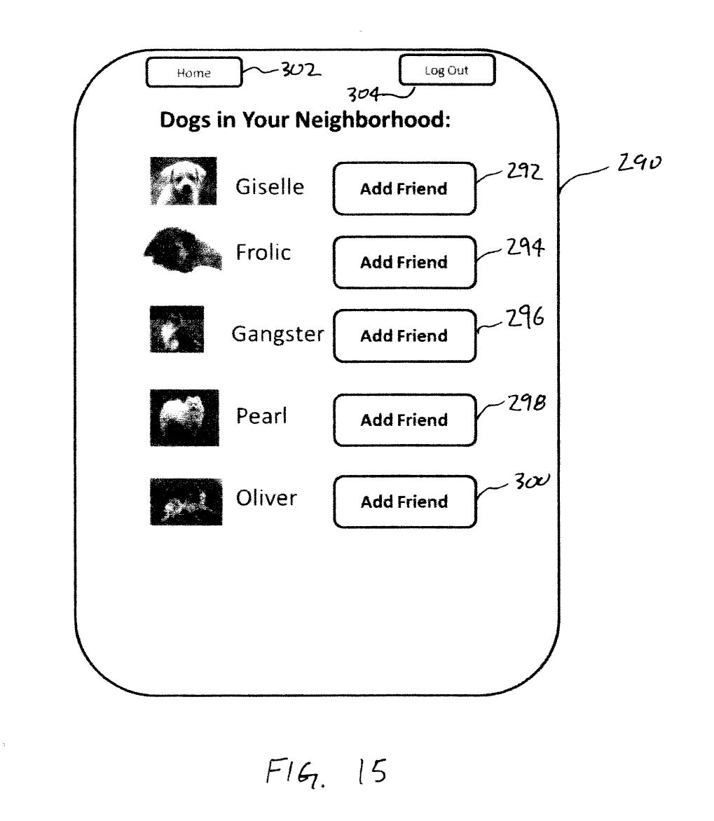

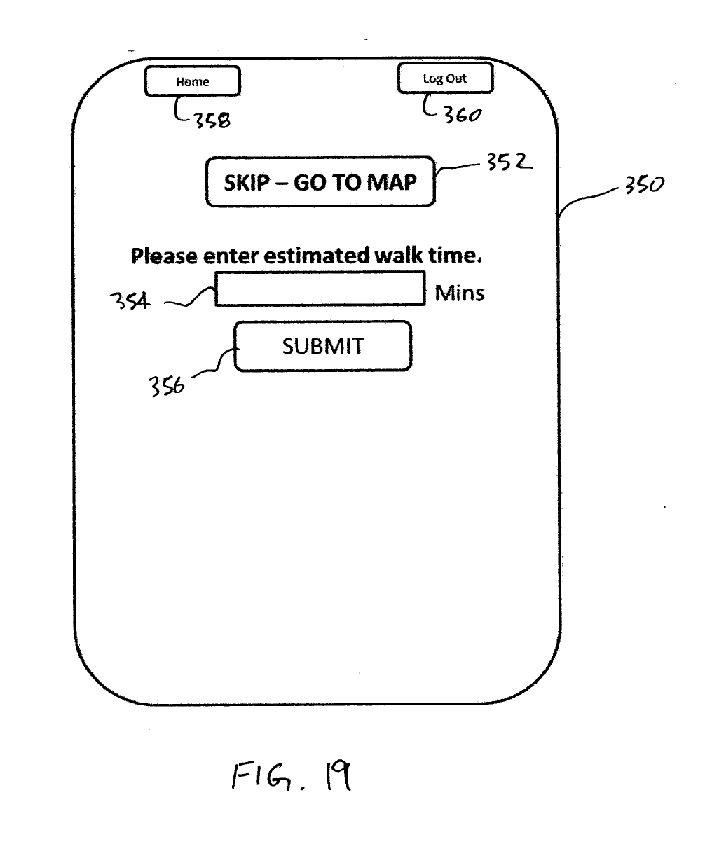

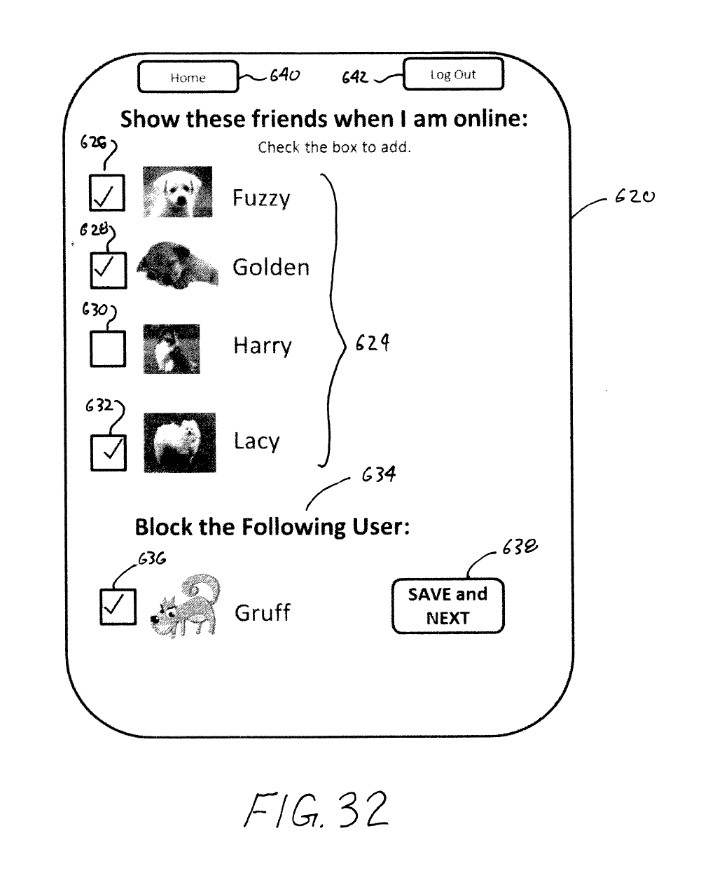

Selecting any of the buttons 192, 194, 196, 198, 200 on the Home page 190 leads to various other interface pages being displayed by the user's smartphone. For example, selecting the Go Online button 192 causes the Walk Time page 350 shown in FIG. 19 to be displayed. Selecting the Find Friends button 194 causes the Dogs in Your Neighborhood page 290 shown in FIG. 15 to be displayed. Selecting the Check Messages button 196 causes the Messages page 270 shown in FIG. 14 to be displayed. Selecting the View Profile page 198 causes the My Profile page 210 shown in FIG. 11 to be displayed. Finally, selecting the Settings button 200 causes the First Change Friends Settings page 620 shown in FIG. 32 to be displayed. These various interface pages are accessed depending on which function the user is attempting to access. Each will be described in turn.

The user selects the View Profile button 198 from the Home page 190 when he or she wishes to view his or her own profile. As mentioned, selecting the View Profile button 198 on the Home Page brings up the My Profile page 210 on the user's smartphone. The My Profile page 210 displays information about the user's dog 212; a picture of the user's dog 214; information about the user 216; and a picture of the user 218. The My Profile page 210 further includes an Edit Profile button 220, a My Friends button 222, a Home button 224, and a Log Out button 226.

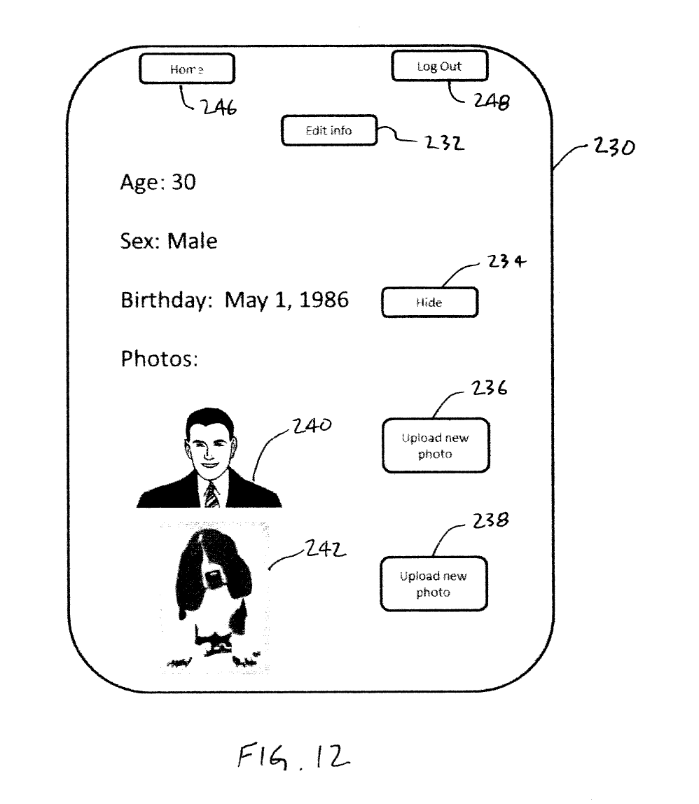

The user may select the Edit Profile button 220 if he or she wished to edit any of the information about himself or herself or the information about his or her dog. The Edit Profile page 230 shown in FIG. 12 is displayed on the user's smartphone when the user selects the Edit Profile button 220 from the My Profile page 210. The Edit Profile page 230 includes an Edit Info button 232, a Hide Birthday button 234, and Upload New Photo button 236 for uploading a new photo of the user, and an Upload New Photo button 238 for uploading a new photo of the user's dog. The Edit Profile page 230 further includes a current user photo 240, a current dog photo 242, a Home button 246, and Log Out button 248. Selecting the Edit Info button 232 causes an additional Edit Profile page to be displayed (not shown) in which the user may edit the information about the user's dog 212 or the the information about the user 216 shown in the my profile page 210 (FIG. 11). Selecting the Hide Birthday button 234 prevents the user's birthday from being displayed on other user's smartphones when the other users view the user's profile. Selecting the Upload New Photo buttons 236, 238 bring up additional pages (not shown) for uploading new profile pictures of the user and the user's dog, respectively. Selecting the Home button 246 on the Edit Profile page 230 causes the user's smartphone to return to the Home page 190 (FIG. 10). Selecting the Log Out button 248 on the Edit profile page 230 causes the user's smartphone to display the Log Out page 680 shown in FIG. 35 and described in more detail below.

Returning to FIG. 11, selecting the My Friends button 222 on the My Profile page 210 causes the Dogs In Your Neighborhood page 290 depicted in FIG. 15 to be displayed on the user's smartphone. The Dogs In Your Neighborhood page 290 shows a list of dogs whose owners are members of the dog walking community supported by the application and who are located in the same geographical area as the user and with whom the user has not previously established a Friend relationship. The list of dogs includes a profile picture of each dog alongside the dog's name. The list further includes an Add Friend button 292, 294, 2967, 298, 300 corresponding to each dog on the list. The Dogs In Your Neighborhood page 290 further includes a Home button 302 and a Log Out button 304.

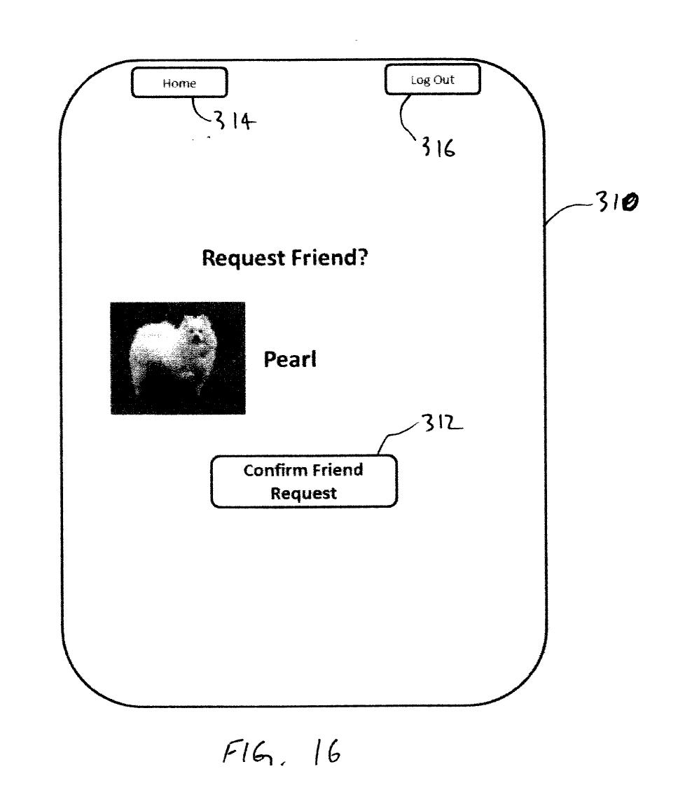

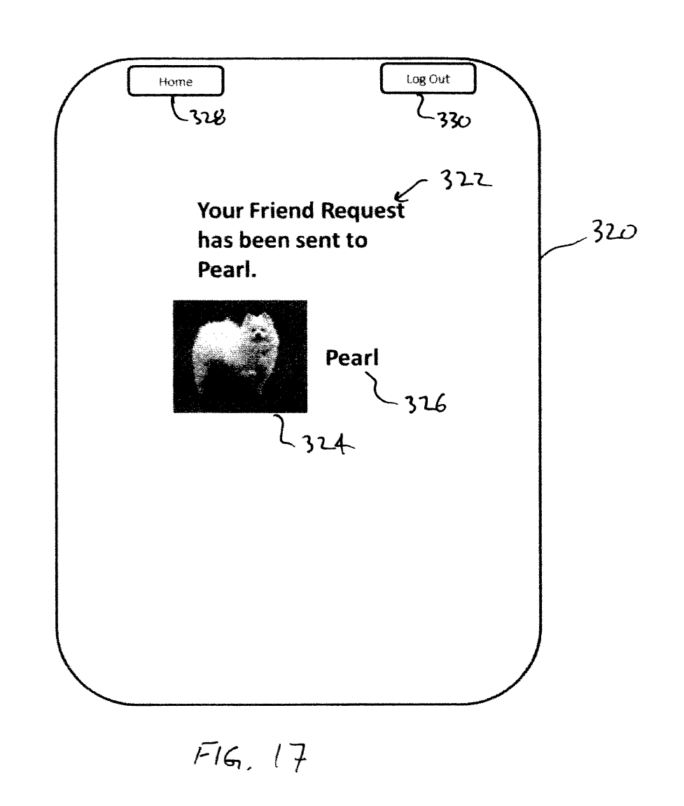

Selecting the Add friend button corresponding to one of the dogs on the list, for example selecting the Add Friend button 298 corresponding the dog Pearl, causes the Request Friend page 310 of FIG. 16 to be displayed on the user's smart phone. The Request Friend page 310 includes a profile picture of the dog Pearl along with a Confirm Friend Request button 312. The Request Friend page 310 further includes a Home button 314 and a Log Out button 316. If the user is certain that he or she would like to add Pearl as a friend via the application, the user selects the Confirm Friend Request button 312. When the user selects the Confirm Friend Request button 312 the application sends the friend request to the web server 14 via the internet 12 (FIG. 1). The web server 14 in turn forwards the friend request to Pearl's owners smartphone, where Pearl's owner may decide to accept or reject the request. Selecting the Confirm Friend Request button 312 causes the Friend Request Message Sent page 320 shown in FIG. 17 to be displayed on the user's smartphone. The Friend Request Message Sent page 320 includes a message 322 indicating that a friend request has been sent, a picture of the dog Pearl 324, and Pearl's name 326. The Friend Request Message Sent page 320 further includes a Home button 328 and a Log Out button 330.

Returning now to FIG. 10 and the Home page 190, the user selecting the Settings button 200 causes the user's smartphone to display the First Change Friends Settings page 620 shown in FIG. 32. The First Change Friends Setting page 620 includes a banner massage 622 reading “Show these friends when I am online:”. The banner message 622 is followed a list 624 of dogs with whom the user is already friends. Each entry on the list includes a corresponding checkbox 626, 628, 630, 632. On the First Change Friends Settings page 620 the user may select the checkbox corresponding to those dogs with which he or she is already friends who the user wishes to be displayed on his or her map (see below) when the user goes online. The First Change Friends Settings Page 620 further includes a banner message 634 reading “Block the following user:”. Below the banner message 634 is a list of dogs the user wishes to block. The entries in this list also include a corresponding checkbox 636. Thus, the user may select dogs and their owners which he or she may not wish to have a relationship with via the application. In this case, the user's profile data will be blocked from appearing on the other user's smartphone. To the other user it will appear that the user does not exist within the dog walking community.

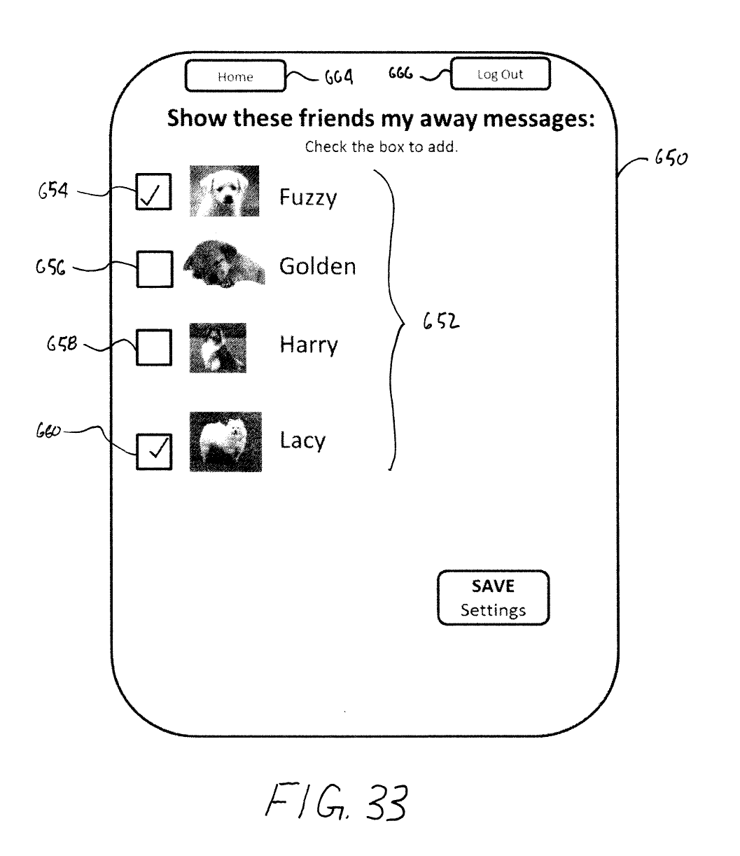

The First Change Friends Settings page 620 further includes a Save and Next button 638, as well as Home and Log Out buttons 640, 642. The user selects the Save and Next button 638 after he or she has made changes in the First Change Friends Setting page 620 and wants to save the changes. Selecting the Save and Next button 638 leads to the Second Change Friends Settings page 650 of FIG. 33 being displayed. The Second Change Friends Settings page 650 includes a banner message 664 that reads: “Show these friends my away messages:”. The banner message 664 is followed by a list 652 of dogs with whom the user is friends. Each entry in the list 652 includes a corresponding checkbox 654, 656, 658, 660. On the Second Change Friends Settings page 650, the user may select those friends whom the user wishes to receive his or her Away Message. As will be described in more detail below, the user's Away Message is a message that will be sent to other user's when the user goes online and is out for a walk with his or her dog. The Second Change Friends Settings page 650 further includes a Save Settings button 662, a Home button 664, and a Log Out button 666. The user selects the Save Settings button 662 after he or she has made changes in the Second Change Friends Setting page 650 and wants to save the changes.

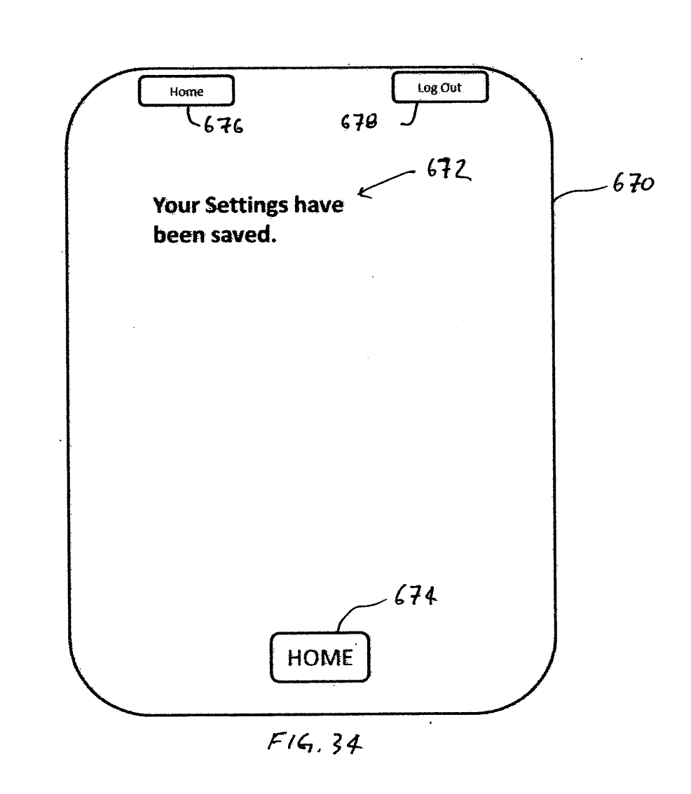

When the user selects the Save Settings button 662 on the Second Change Friend Settings page 650, The Changed Settings Confirmation page 670 shown in FIG. 34 is displayed. The Changed Settings Confirmation page 670 displays a message 672 indicating that the changes to the user's settings have been changed. The Changed Settings Confirmation page 670 also includes a Home button 674 and a Log Out button 676.

Returning again to the Home page 190 shown in FIG. 10, the user may select the Check Messages button 196 when he or she wishes to review messages that have been sent to the user from other members of the dog walking community. Selecting the Check Messages button 196 causes the Messages page 270 shown in FIG. 14 to be displayed by the user's smartphone. The Messages page 270 displays a list of messages 272, 274, 276, 278 sent to the user from other members of the dog walking community, as well as messages 280 sent from the user to other members of the dog walking community.

Once more returning to FIG. 10, the user may select the Find Friends button 194 from the Home page 190. Selecting the Find Friends button 194 causes the Dogs In Your Neighborhood page 290 depicted in FIG. 15 to be displayed. As has already been described, the Dogs In Your Neighborhood page 290 shows a list of dogs whose owners are members of the dog walking community enabled by the present invention. The user may select one of the Add Friend buttons 292, 294, 296, 298, 300 on the Dogs in Your Neighborhood page 290 corresponding to a dog with whom the user wishes to establish a Friend relationship, as has already been described.

Returning again to FIG. 10, the user may select the Go Online button 192 from the Home page 190 when the user is preparing to go on a walk, or has already begun walking with his or her dog and wishes to see which other members of the dog walking community are out and about with their dogs. By going online, the user likewise makes his or her dog walking activities visible to the other members of the dog walking community who happen to be online at that time. For example, when the user selects the Go Online button 192 his or her status is communicated to the web server 14. Similarly, the user's location, intended route, and the estimated duration of the user's walk may also be communicated to the web server 14. Furthermore, the information regarding the user's online status along with other information about the user's plans for his or her present dog walking activities may be forwarded to other users so that there interface devices may be made to display information about the current user on their smartphones much the same way their information is displayed on the user's smartphone.

Selecting the Go Online button 192 from the Home page 190 causes the Walk Time page 350 shown in FIG. 19 to be displayed on the user's smartphone. The Walk Time page 350 includes a Skip—Go To Map button 352, an Estimated Walk Time text field 354, and a Submit button 356. From the Walk Time page 350 the user has the option of entering information about his or her dog walking plans so that other users may view his or her itinerary. Alternatively, the user may continue directly to an interactive map that displays information about other users in the area who are online and out walking their dogs. If the user chooses to enter information about his or her planned walk itinerary, the user enters an estimated walk time in the Estimated Walk Time text field 354 and selects the Submit button 356. In contrast, if the user chooses to go straight to the interactive map without entering information about his or her own dog walking plans, he or she may simply select the Skip-Go To Map button 352. The Walk Time page 350 includes a Home button 358 and a Log Out button 360. Selecting the Home Button 358 returns the user to the Home page 190. Selecting the Log Out button 284 initiates the sequence of logging the user off the system as will be described in more detail below.

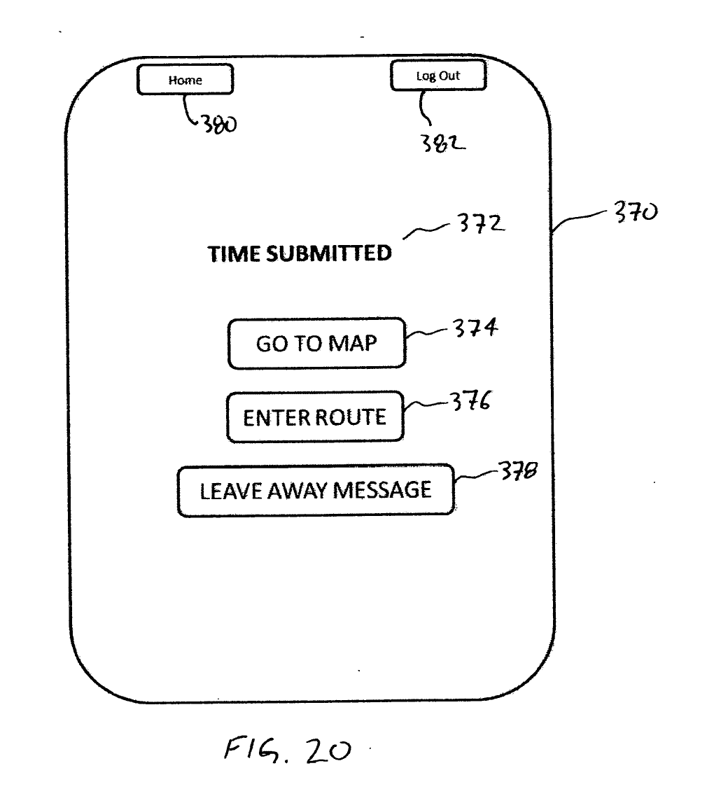

If the user chooses to enter an estimated walk time in the Estimated Walk Time text field 354, subsequently selecting the Submit button 356 causes the Time Submitted page 370 shown in FIG. 20 to be displayed on the user's smartphone. The Time Submitted page 370 includes a confirmation message 372 confirming that the user's estimated walk time has been successfully submitted. The Time Submitted page 374 further includes a Go To Map button 374, an Enter Route button 376, and a Leave Away Message button 378. The Time Submitted page 370 further includes a Home button 380 and Logout button 382. Selecting the Home button 380 returns the user to the Home page 190 (FIG. 10). Selecting the Log Out button 382 initiates a Log Out sequence as will be described below.

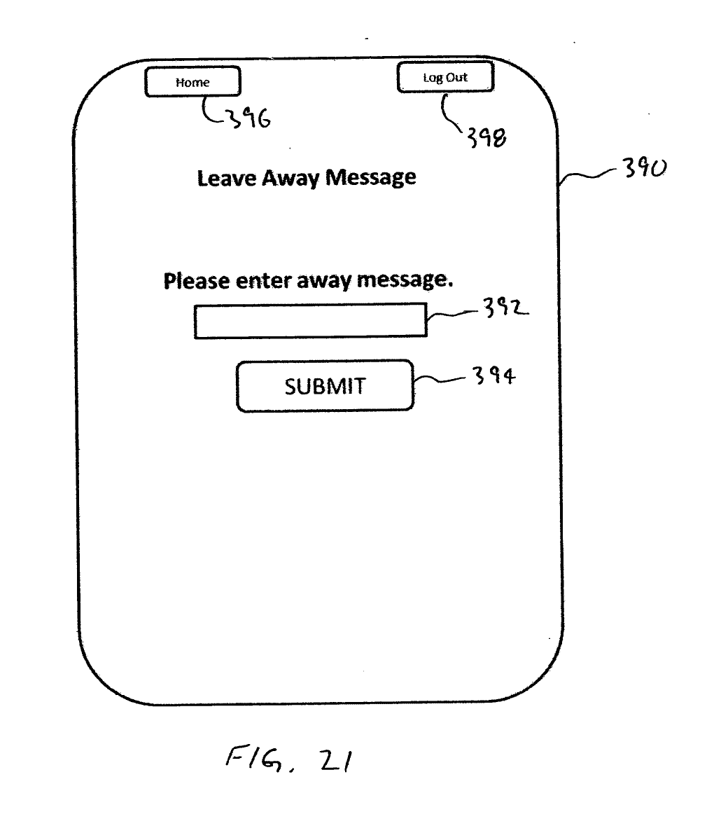

Selecting the Leave Away Message button 378 from the Time submitted page 370 causes the Leave Away Message page 390 depicted in FIG. 21 to be displayed on the user's smartphone. The Leave Away Message page 390 includes an Away Message text field 392 for receiving text entered by the user corresponding to the user's desired away message. Once the user has entered his or her desired away message, the user may select the Submit button 394. Selecting the Submit button 394 causes the user's away message to be sent to the web server 14 (FIG. 1) which in turn may retransmit the user's away message as appropriate to other members of the dog walking community who have been designated by the user to receive his or her away messages.

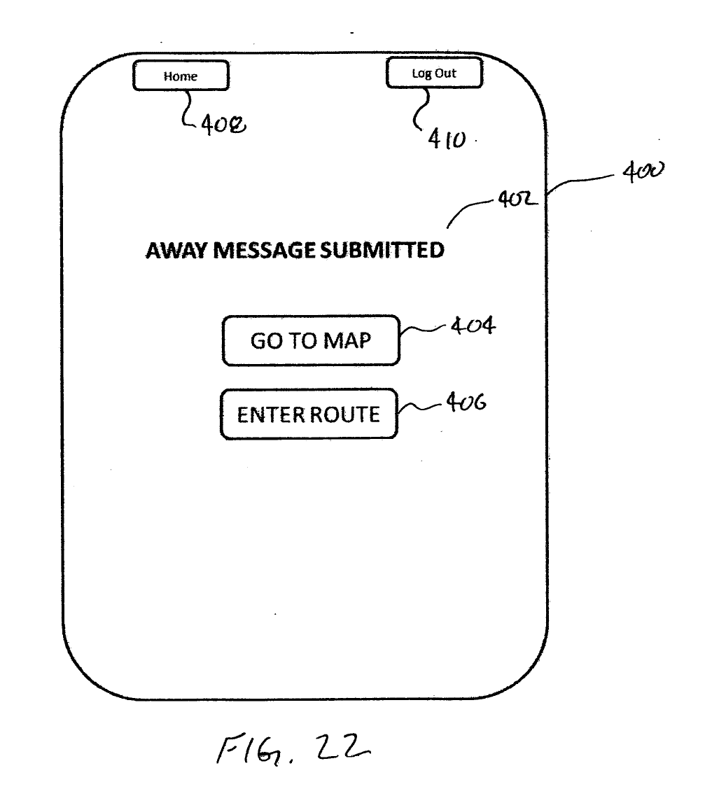

Selecting the Submit button 394 further causes the Away Message Submitted page 400 depicted in FIG. 22 to be displayed on the user's smartphone. The Away Message Submitted page 400 includes an Away Message Submitted confirmation message 402 indicating that the user's away message has been successfully submitted. The Away Message Submitted page 400 further includes a Go To Map button 404 and an Enter Route Button 406. The Away Message Submitted page 400 further includes a Home button 408 and a Log Out button 410. Selecting the Home button 408 returns the user to the Home page 190 (FIG. 10). Selecting the Log Out button 410 initiates the Log out sequence described in detail below.

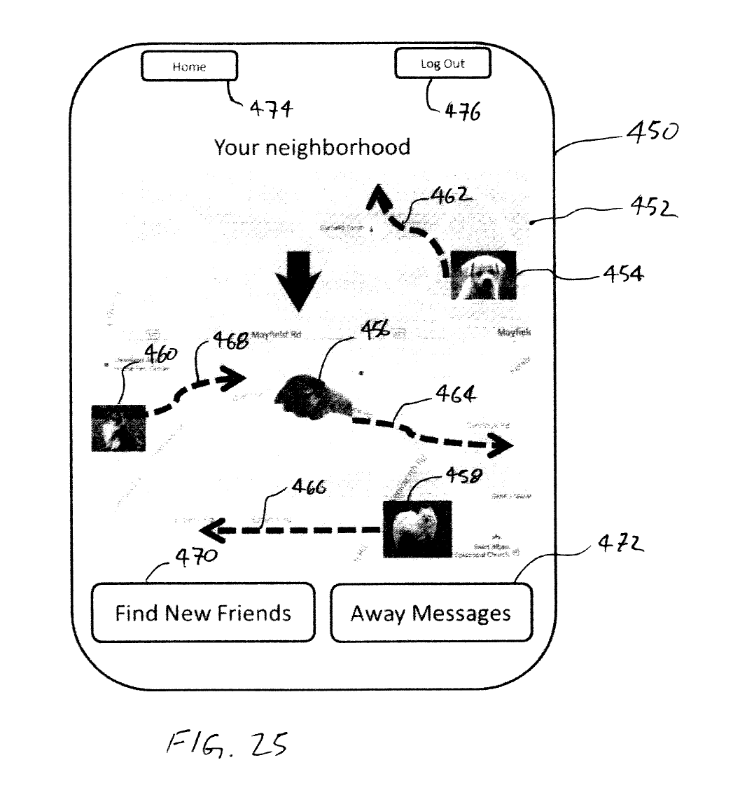

Selecting the Go To Map Button 404 causes a Your Neighborhood page 450 depicted in FIG. 25 to be displayed by the user's smartphone. The Your Neighborhood page 450 includes an interactive map 450 of the user's neighborhood. The interactive map 452 and the features accessed via the interactive map 452 will be discussed in more detail below.

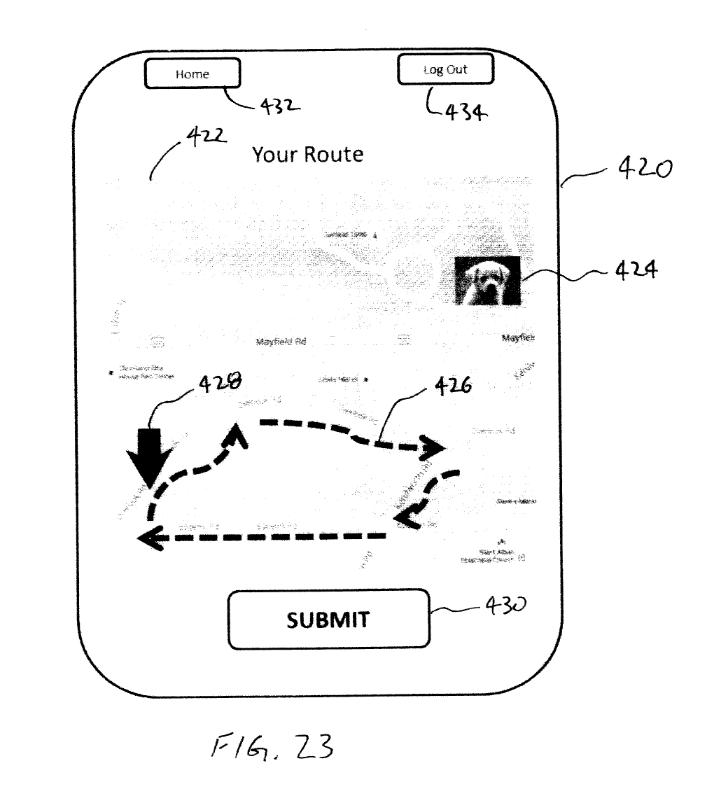

Meanwhile, returning to the Away Message Submitted page 400 of FIG. 22, selecting the Enter Route button 406 causes an Enter Route page 420 depicted in FIG. 23 to be displayed on the user's smartphone. The Enter Route page 420 includes an interactive map 422 representing the user's neighborhood. A profile image of the user's dog 424 is superimposed on the map 422 indicating that it is the user's route being viewed, not some other dog owner's planned route. The map 422 further includes an arrow 428 indicating the user's present location. The user enters his or her planned route by selecting points on the map in sequence according to the route the user intends to follow. The routed entered by the user is represent by a dashed line 426 with arrows indicating the user's planned direction of travel. Once the user has entered his or her route the user may submit the route by selecting a Submit button 430. Selecting the Submit button 430 causes the entered route to be transmitted to the web server 14 (FIG. 1) where it is recorded with the user's profile in the data store 16. Thus, the user's planned route 426 may be made available to other members of the dog walking community when they go online to view dog walking activity in their neighborhood. The Enter Route page 420 further includes a Home button 432 and a Log Out button 434. Selecting the Home button 408 returns the user to the Home page 190 (FIG. 10). Selecting the Log Out button 434 initiates the Log out sequence described in detail below.

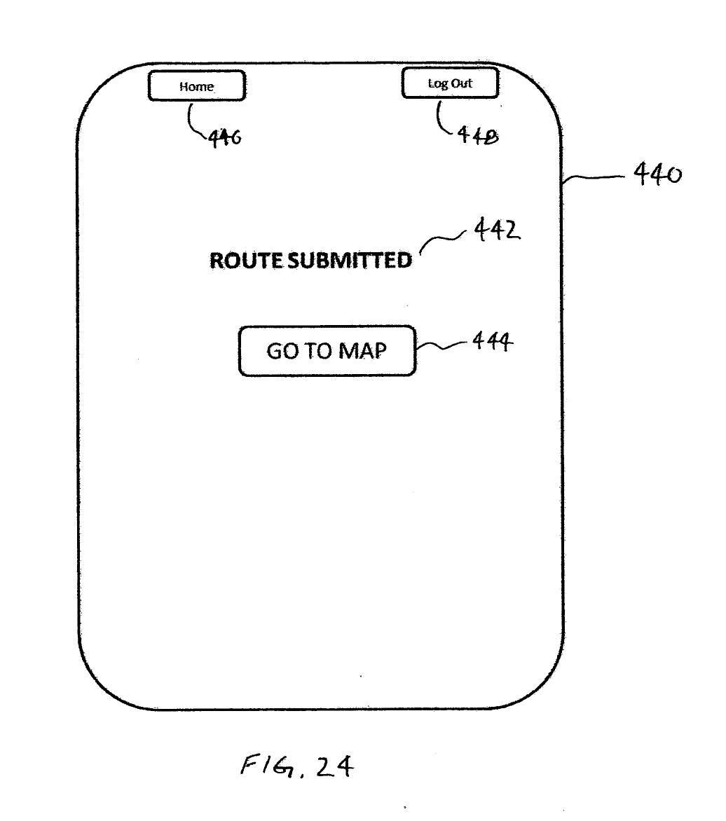

In addition to transmitting the user's route to the web server 14, selecting the Submit button 430 on the Enter Route page 420 causes the Route Submitted page 420 shown in FIG. 24 to be displayed on the user's smartphone. The Route Submitted page 440 includes a confirmation message 442 indicating that the user's route has been successfully submitted. The Route Submitted page 440 also include a Go To Map button 444, a Home button 446, and a Log Out button 448. Selecting the Go To Map button 444 leads to the Your Neighborhood page 450 shown in FIG. 25 being displayed by the user's smartphone. Selecting the Home button 446 returns the user to the Home page 190 (FIG. 10). Selecting the Log Out button 448 initiates the Log Out sequence described in detail below.

The Your Neighborhood page 450 shown in FIG. 25 is the primary interface page through which the user may access information regarding the activities of other users in the dog walking community. As has already been described, the user may access the Your neighborhood page 450 a number of different way. For example, the user may access the Your Neighborhood page 450 by selecting the Skip-Go To Map button 352 on the Walk Time page 350 (FIG. 19); selecting the Go To Map button 374 on the Time Submitted page 370 (FIG. 20); selecting the Go To Map button 404 on the Away Message Submitted page 400 (FIG. 22); or by selecting the Go To Map button 444 on the Route Submitted page 440

The Your neighborhood page 450 includes an interactive map 452 representing the user's neighborhood. The map 450 displays an arrow 478 indicating the user's current location. The map 450 further includes a number of icons or profile images 454, 456, 458, 460 of dogs in the user's area whose owners are currently online. The dog profile images 454, 456, 458, 460 are displayed at locations on the map representing their present real world locations. Dashed arrows 462, 464, 466, 468 attached to the dog profile images 454, 456, 458, 460 indicate the dog and owner's present direction of travel. Thus, by simply glancing at the interactive map 452 the user may quickly determine which dogs are out and about with their respective owners, where they are presently located and the direction in which they are traveling. With this information the user can easily chart a course from his or her current location to meet up with a dog and/or dog owner with whom he or she would like to get together.

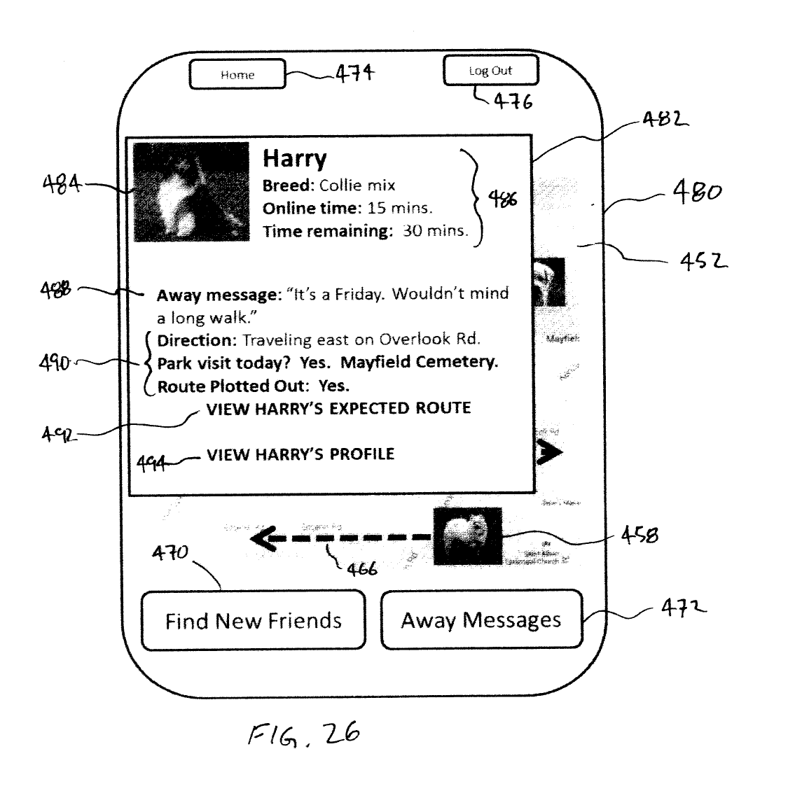

As mentioned, the map 450 is interactive. The user may select the profile image 454, 456, 458, 460 of a particular dog he or she is interested in learning more about. When the user selects one of the dog profile images from the map 450, a pop-up window appears on the user's smartphone with additional information about the selected dog. For example, FIG. 26 illustrates a pop-up window 482 corresponding to the selection of a dog profile image 460 from the interactive map 450. The pop-up window 482 includes an enlarged profile picture of the dog 484 so the user can get a better look at the selected dog. The Pop-up window further includes information 486 about the dog, including the dog's name (in this case Harry), breed, the length of time the dog's owner has been online, and how much longer the dog's owner intends to be online. The pop-up window 482 further includes an Away Message 488 entered by the dog's owner, and information 490 about the dog owner's planned activities for the dog.

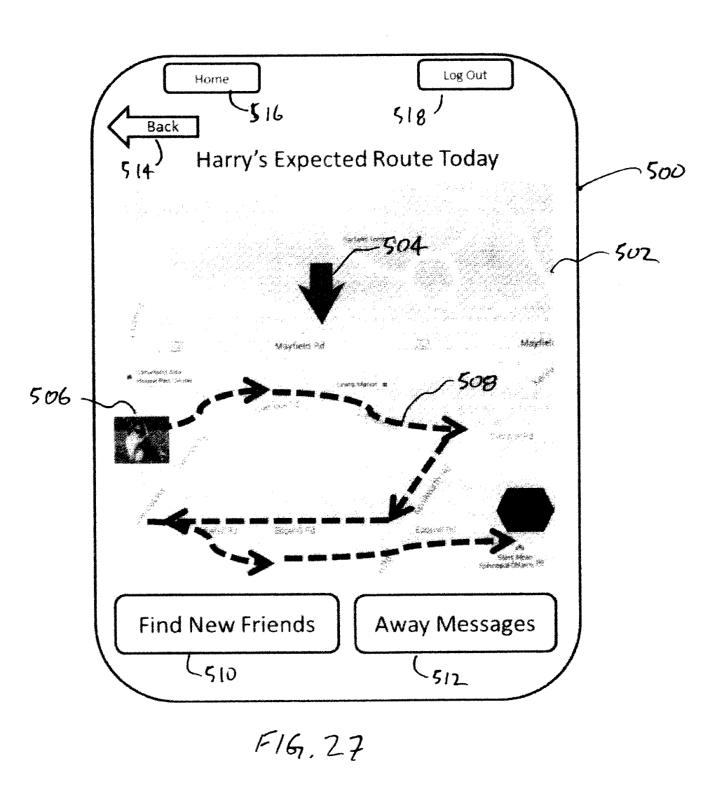

Links 492, 494 included in the pop-up window 482 allow the user to access additional interface pages that include more detailed information about the selected dog. A first link 492 allows the user to view the selected dog's expected route. Selecting the first link 492 causes the Expected Route page 500 shown in FIG. 27 to be displayed on the user's smartphone. The Expected Route page 500 includes a map 502 of the selected dog's neighborhood. An arrow 504 shows the user's current location. The selected dog's profile picture is shown on the map 502 in a location representing the starting point of the dog's expected route, and a dashed line with arrows 508 indicates the route the dog's owner is expecting to take. A Back arrow 514 allows the user to return to the Your neighborhood page 480 when he or she is finished reviewing the selected dog's route. The Expected Route page 500 further includes Find New Friends and Away Messages buttons 510, 512 which operate in the same manner as the Find New Friends and Away Messages buttons 470, 472 on the Your neighborhood page 450 of FIG. 25. Finally, the Expected Route page 500 includes a Home button 516 and a Log Out button 518. Selecting the Home button 516 returns the user to the Home page 190 (FIG. 10). Selecting the Log Out button 518 initiates the Log Out sequence described in detail below.

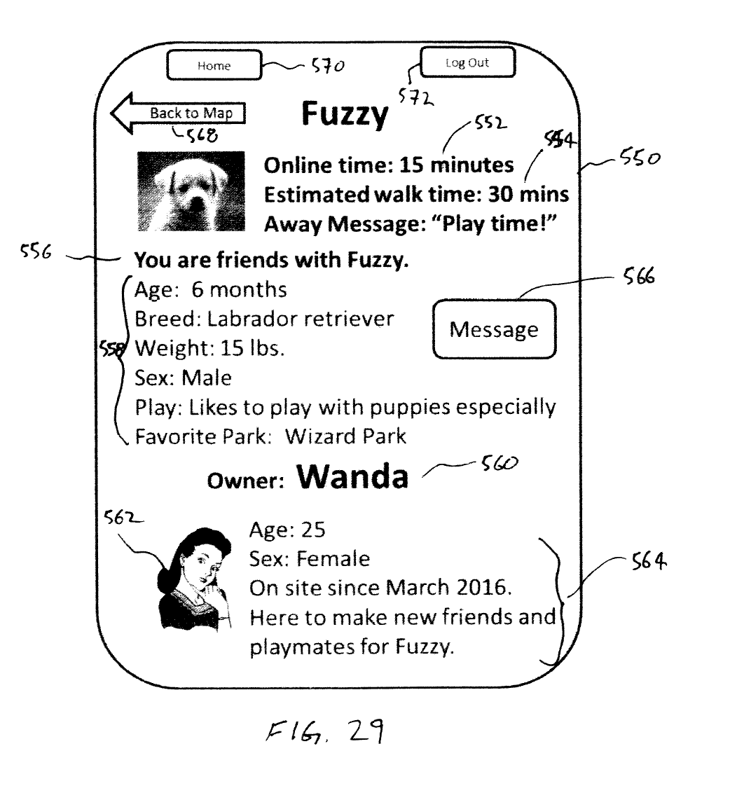

A second link 494 included in the pop-up window 482 allows the user to access the selected dog's full profile. Selecting the link 494 causes the Profile page 550 depicted in FIG. 29 to be displayed on the user's smartphone. The Profile page 550 includes the selected dog's name 551 (in this case “Fuzzy”) and the dog's profile picture 553. Information regarding the dog's (or the dog owner's) current activities 552 is displayed along with the dog's Away Message 554. An indication 556 whether the user is friends with the dog is also provided. The dog's profile further includes various information about the dog 558 including the dog's age, the breed, weight, sex, etc. The profile page 550 also includes information about the dog's owner, including the owner's name 560; the owner's profile picture 562; and various personal information about the user 564.

A message button 566 is provided on the Profile page 550 allowing the user to send a message to the owner of the dog profiled in the Profile page 550. A Back to Map button 568 allows the user to return to the Your Neighborhood page 450 (FIG. 25). Lastly, the Profile page 550 includes a Home button 570 and a Log Out button 572. Selecting the Home button 570 returns the user to the Home page 190 (FIG. 10). Selecting the Log Out button 572 initiates the Log Out sequence described in detail below.

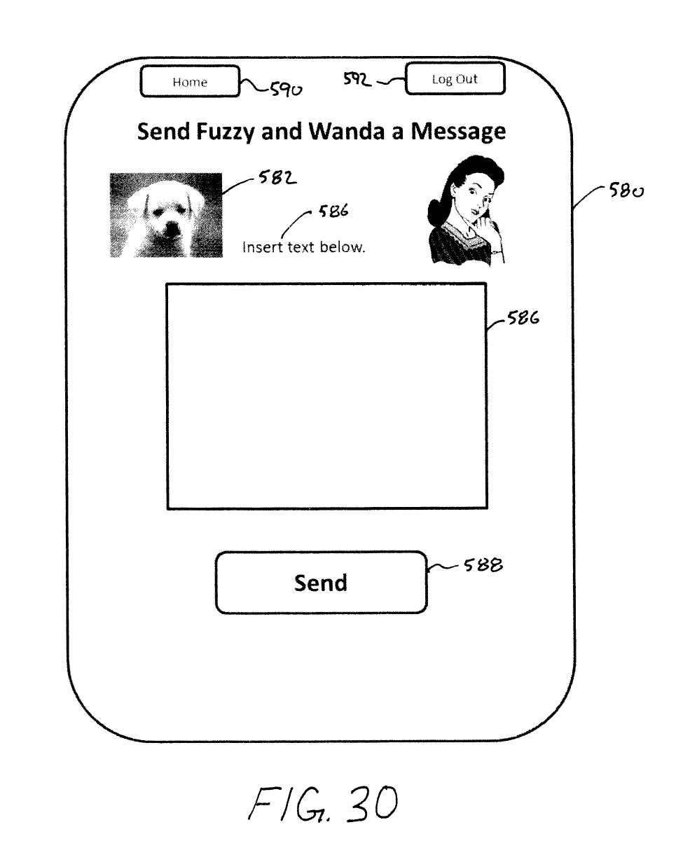

Selecting the Message button 566 from the Profile page 550 causes the Send Message page 580 depicted in FIG. 30 to be displayed on the user's smartphone. The Send Message page 580 includes the profile picture 582 of the dog being contacted, as well as the profile picture 584 of the dog's owner. A prompt 586 instructs the user to enter a message in a message text box 586. Once the user has entered his or her message, the user may select a Send button 588 located below the text box 586.

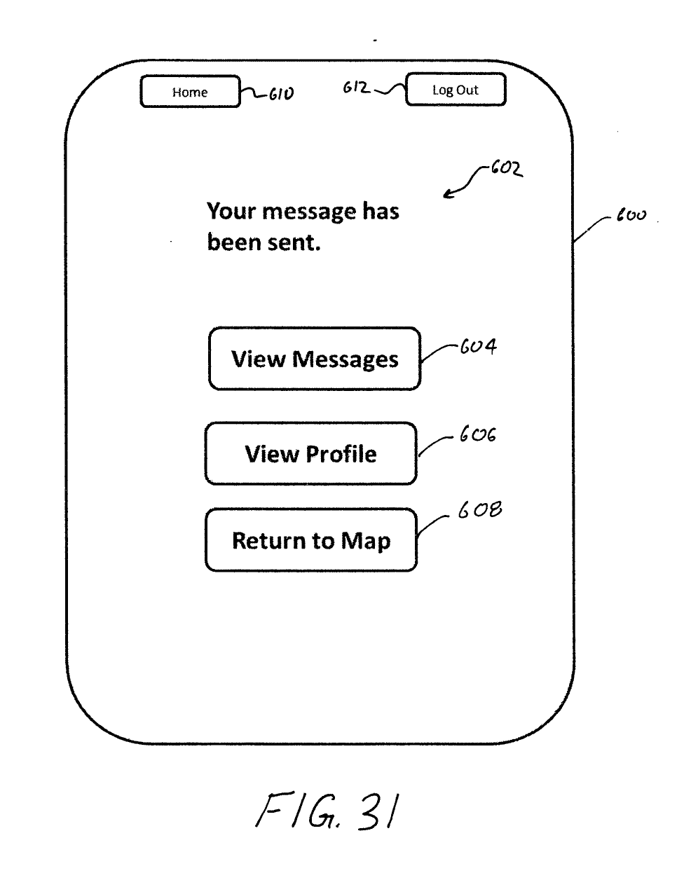

Selecting the Send button 588 on the Send Message page 580 causes the message entered into to text box 586 to be transmitted to the web server 14 (FIG. 1) which in turn forwards the message to the selected dog owner's smartphone. Selecting the Send button 588 further causes the Message Sent confirmation page 600 shown in FIG. 31 to be displayed on the user's smartphone. The Message Sent confirmation page 600 displays a message 602 confirming that the user's message has in fact been sent.

The Message Sent page 600 further includes a View Messages button 604, a View Profile button 606 and a Return to Map button 608. Selecting the View Messages button 604 causes the Messages page 270 (FIG. 14) to be displayed on the user's smartphone. The Messages page 270 allows the user to view messages received from other users as well as messages the user has sent to other users, as has already been described. Selecting the View Profile button 606 from the Message Sent confirmation page 600 causes the My Profile page 210 (FIG. 11) to be displayed on the user's smartphone, allowing the user to review his or her profile information as has already been discussed. Selecting the Return to Map button 608 from the Message Sent confirmation page 600 returns the user to the Your Neighborhood page 450 (FIG. 25). Finally, the Message Sent confirmation page 600 includes a Home button 610 and a Log Out button 612. Selecting the Home button 610 returns the user to the Home page 190 (FIG. 10). Selecting the Log Out button 612 initiates the Log Out sequence described in detail below.

Returning to FIG. 25, the Your Neighborhood page 450 includes a Find New Friends button 470 and an Away Messages button 472. Selecting the Find New Friends button 470 causes the Dogs in Your Neighborhood page 290 (FIG. 15) to be displayed. The Dogs in Your Neighborhood page 290 allows the user to establish Friend relationships with dogs in the user's area and their owners as previously discussed.

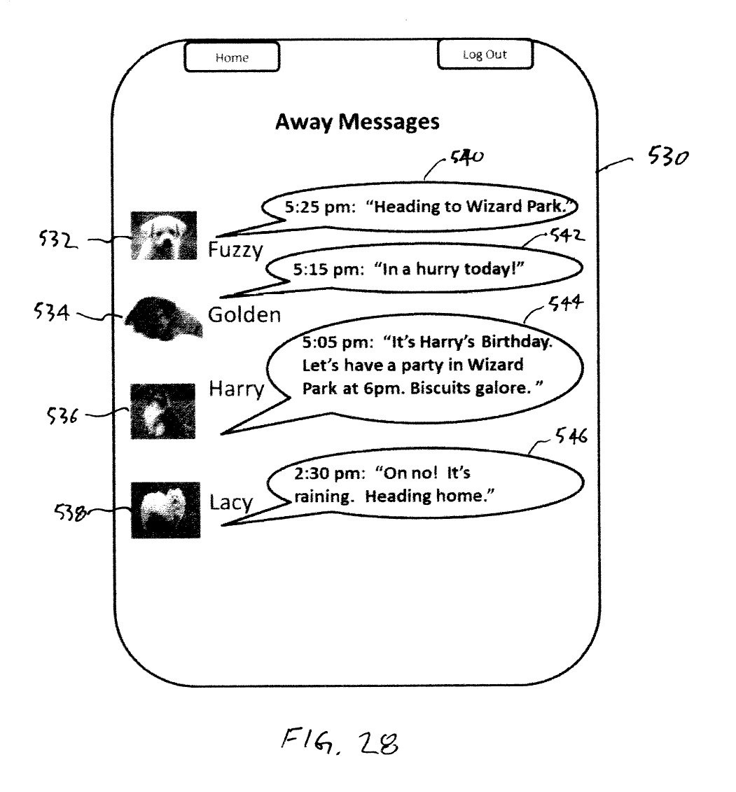

Selecting the Away Messages button 472 causes the Away Messages page 530 depicted in FIG. 28 to be displayed on the user's smartphone. The Away Messages page 530 includes profile pictures 532, 534, 536, 538 of the dogs in the user's area with whom the user has established a Friend relationship. The Away Message page 430 also includes the away messages 540, 542, 544, 546 entered by each of the dogs' 532, 534, 536, 538 owners. The Away Message page 430 further includes a Home button 548, and a Log Out button 549. Selecting the Home button 548 returns the user to the Home page 190 (FIG. 10). Selecting the Log Out button 549 initiates the Log Out sequence described below.

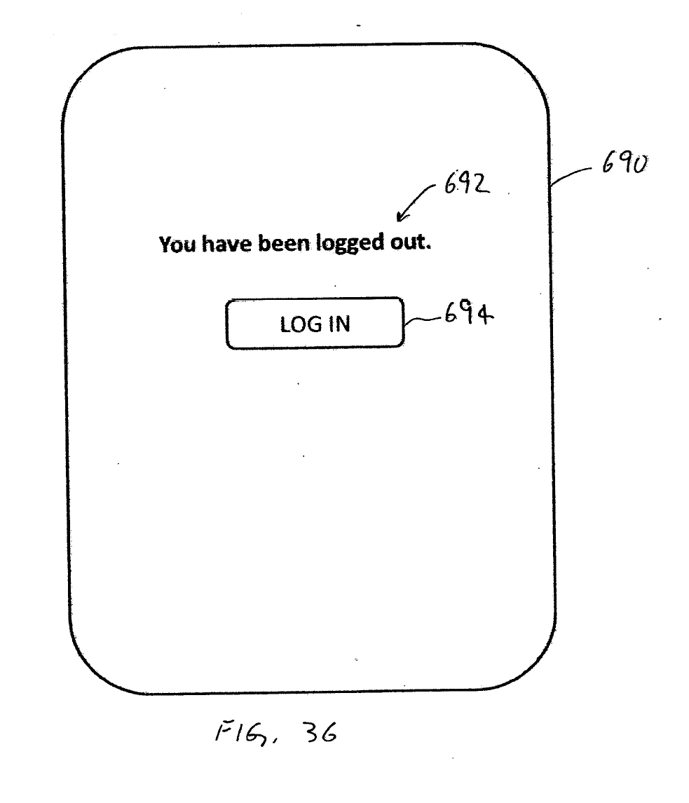

The user may choose to go offline, or log out of the dog walking application at any time. As has already been described, many of the interface pages of the application executed by the user's smartphone include a Log Out button. Selecting the Log Out button from any of those interface pages will cause the user's smartphone to display the Log Out page 680 shown in FIG. 35. The Log Out page 680 includes a prompt 682 asking whether the user is certain he or she wants to log out. The Log Out page further includes a Yes. Log Out button 684 and a No. Return to Home button 686. If the user decides he or she does not in fact wish to log out, selecting the No. Return to Home button 686 will return the user to the application Home Page 19 (FIG. 10). If, however, the user truly does wish to log out, selecting the Yes. Log Out button 684 will cause a the user's profile to be updated at the Web server 14 (FIG. 1) indicating that the user is no longer online. Selecting the Yes. Log Out button 684 further causes the Logged Out page 690 depicted in FIG. 36 to be displayed on the user's smartphone.

The Logged out page 690 includes a message 692 confirming that the user has in fact been logged out. The Logged Out page 690 further includes a Log In button 694 which allow the user to go back online with the application. Selecting the Log In button 694 from the Logged Out page 690 returns the user to the Log In page 40 (FIG. 2).

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within scope of the invention, as defined by the claims.

I claim:

1. A method of coordinating activities among a plurality of pet Owners, the method comprising the steps of:
collecting profile information from a plurality of pet owners and storing the information in a database, the profile information including a pet owner name and a pet name for each of at least one pet owned by each pet owner among said plurality of pet owners;
receiving indicia from a first pet owner among said plurality of pet owners indicating that the first pet owner is active;
receiving route and time information from the first pet owner, the route information describing a path the first pet owner intends to follow while walking with a first pet belonging to the first pet owner, and the time information corresponding to a time period during which the first pet owner intends to be walking with the first pet;
receiving regular first pet owner GPS position updates indicating a first pet owner's location;
determining a first pet owner's direction of travel based on the regular first pet owner GPS position updates;
receiving indicia from a second pet owner among said plurality of pet owners indicating that the second pet owner is active;
sending first pet owner profile information collected from the first pet owner, the route and time information received from the first pet owner, one or more GPS position updates indicating the first pet owner's location, and the first pet owner's direction of travel to the second pet owner;
displaying a map to the second pet owner, the map indicating the first pet owner's location and the first pet owner's direction of travel;
receiving a first input command from the second pet owner;
displaying profile information collected from the first pet owner for the second pet owner in response to the first input command received from the second pet owner;
receiving a second input command received from the second pet owner;
displaying the route information received from the first pet owner for the second pet owner in response to the second input command received from the second pet owner.

2. The method of claim 1 further comprising the steps of:
receiving route and time information from the second pet owner, the route information describing a path the second pet owner intends to follow while walking with a second pet belonging to the second pet owner, and the time information corresponding to a time period during which the second pet owner intends to be walking with the second pet belonging to the second pet owner;
receiving regular second pet owner GPS position updates indicating the second pet owner's location;
determining a second owner's direction of travel based on the regular second pet owner GPS position updates;
sending second pet owner profile data collected from the second pet owner, the route and time information received from the second pet owner, one or more second pet owner GPS position updates indicating the second pet owner's location, and the second pet owner's direction of travel to the first pet owner;
receiving a first input command from the first pet owner;
displaying profile information collected from the second pet owner for the first pet owner in response to the first input command received from the first pet owner;
receiving a second input command from the first pet owner; and
displaying the route information received from the second pet owner for the first pet owner.

3. The method of claim 1 further comprising the steps of:
receiving a message from the second pet owner; and
transmitting the message to a subset of pet owners from among the plurality of pet owners; and
displaying the message to the pet owners within the subset of pet owners.

4. The method of claim 1 wherein the step of displaying the route information received from the first pet owner for the second pet owner comprises superimposing a graphical representation of the route information on the map displayed to the second user.

5. The method of claim 1 wherein the step of displaying profile information collected from the first pet owner for the second pet owner comprises displaying a profile picture of the first pet belonging to the first pet owner.

6. The method of claim 5 wherein the step of displaying profile information collected from the first pet owner for the second pet owner further comprises displaying a pet name corresponding to the first pet belonging to the first pet owner.

7. The method of 5 wherein the step of displaying profile information collected from the first pet owner for the second pet owner further comprises displaying a pet breed corresponding to the first pet belonging to the first pet owner.

8. The method of claim 5 wherein the step of displaying profile information collected from the first pet owner for the second pet owner comprises displaying a hypertext link to a profile page corresponding to the first pet owner and the first pet belonging to the first pet owner.

9. The method of claim 1 wherein the step of receiving a second input command received from the second pet owner comprises executing a hypertext link to a map including a graphical representation of the route information received from the first pet owner.

10. A method of coordinating perambulatory activities among a plural of individuals, the method comprising the steps of:
collecting profile information from a plurality of individuals and storing the information in a database, the profile information including at least an individual's name;
receiving indicia from a first individual among said plurality of individuals indicating that the first individual is active;
receiving route and time information from the first individual, the route information describing a path the first pet owner intends to follow during a perambulatory activity, and the time information corresponding to a time period during which the first individual intends to perambulate;
receiving regular first individual GPS position updates indicating a first individual's location;
determining a first individual's direction of travel based on the regular first individual GPS position updates;
receiving indicia from a second individual among said plurality of individuals indicating that the second individual is active;
sending first individual profile information collected from the first individual, the route and time information received from the first individual, one or more GPS position updates indicating the first individual's location, and the first individual's direction of travel to the second individual;
displaying a map to the second individual, the map indicating the first individual's location and the first individual's direction of travel;
receiving a first input command from the second individual;
displaying profile information collected from the first individual for the second individual in response to the first input command received from the second individual;
receiving a second input command received from the second individual;
displaying the route information received from the first individual for the second individual in response to the second input command received from the second individual.

11. The method of claim 10 wherein the perambulatory activity comprises running and the plurality of individuals comprises a plurality of runners.

12. The method of claim 10 wherein the perambulatory activity comprises walking and the plurality of individuals comprises a plurality of parents walking with children.

13. The method of claim 10 wherein the perambulatory activity comprises walking a dog and wherein the plurality of individuals comprises a plurality of dog minders.
